(19) United States
(12) Patent Application Publication
(10) Pub. No.: US 2008/0008258 A1
(43) Pub. Date: Jan. 10, 2008

(54) WIRELESS RECEIVING APPARATUS AND METHOD

(76) Inventor: Yasuhiko Tanabe, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/672,233

(22) Filed: Feb. 7, 2007

(30) Foreign Application Priority Data
Jul. 5, 2006 (JP) 2006-185876

(51) Int. Cl. H04L 1/02

(52) U.S. Cl. 375/267

(57) ABSTRACT

A wireless receiving apparatus includes antennas, a receiving unit configured to receive multiple input multiple output-orthogonal frequency division multiplexing (MIMO-OFDM) signals via the antennas, an estimation unit configured to estimate channel response values of subcarriers included in the MIMO-OFDM signals, a first computation unit configured to compute an estimated channel-response error common to the subcarriers based on the estimated channel response values, a response correction unit configured to correct the estimated channel response values using the estimated channel-response error, and a second computation unit configured to perform preprocessing for demodulating the MIMO-OFDM signals, using the corrected channel response values.

### CROSS-REFERENCE TO RELATED APPLICATIONS

This application is based upon and claims the benefit of priority from prior Japanese Patent Application No. 2006-185876, filed Jul. 5, 2006, the entire contents of which are incorporated herein by reference.

### BACKGROUND OF THE INVENTION

1. Field of the Invention

The present invention relates to a wireless receiving apparatus and method for correcting an estimated channel response value using signals received through a plurality of subcarriers, which employ Multiple Input Multiple Output-Orthogonal Frequency Division Multiplexing (MIMO-OFDM) for communication using a plurality of transmission/receiving antennas.

2. Description of the Related Art

MIMO transmission for distributing a transmission signal to a plurality of radio units and simultaneously transmitting a plurality of signals, output from the radio units, through a plurality of transmission antennas, using a single frequency has been proposed as a technique for increasing the speed of wireless communication (see, for example, A. Paulraj, R. Nabar, and D. Gore, Introduction to Space-Time Wireless Communications, Cambridge University Press, UK, 2003, pp. 6-10). In MIMO transmission, the signals transmitted from the antennas are passed through different channels and simultaneously received by a receiver. The receiver receives the signals using their respective antennas, and decode/demodulate the received signals into the transmission signal. This enables the speed of transmission to be increased in accordance with the number of signals multiplexed, without widening the frequency band used for communication. Thus, the MIMO transmission can enhance the efficiency of use of frequencies and the throughput.

In multipath transmission, in the environment in which signals transmitted have different propagation delays, waveform distortion due to intersymbol interference is a great factor for degrading the quality of communication. Orthogonal Frequency Division Multiplexing (OFDM) is known as a technique for compensating waveform distortion due to intersymbol interference between signals of different propagation delays.

In the field of wireless communication, attention is now paid to MIMO-OFDM transmission, acquired by combining the above-described OFDM transmission with MIMO transmission, as a scheme that can enhance the speed of communication, the quality of communication, the efficiency of use of frequencies, and the throughput.

In general, transmission apparatuses for wireless communication transmit a radio-frequency signal acquired by converting a baseband signal, while receiving apparatuses convert the received radio-frequency signal into a baseband signal, and then subject it to receiving processing. The transmission apparatuses and receiving apparatuses use respective receivers for generating sine waves. In general, it is difficult to generate accurate sine waves, which may well cause frequency offsets.

As a result, an unnecessary phase rotation and hence a phase error occurs in the received signal with lapse of time, which is a factor of a degradation in the quality of communication To avoid this, in OFDM, in general, some subcarriers are set as subcarriers (hereinafter referred to as “pilot subcarriers”) used by a receiving apparatus for transmitting known pilot signals, i.e., reference signals including known signals are used for data transmission.

In some conventional wireless receiving apparatuses, the streams included in the received signal components of pilot subcarriers are separated, the average of phase errors is computed, and the phase error in the corresponding symbol is corrected (see, for example, JP-A 2005-252602 (KOKAI)).

However, the conventional wireless receiving apparatuses cannot correct errors that occur during channel response estimation because of phase errors. Further, since phase errors are estimated after streams are separated from each other, the estimation accuracy of the phase errors significantly depends upon channel response values. When the channel response values have high correlation, the estimation accuracy and hence the receiving performance are degraded.

### BRIEF SUMMARY OF THE INVENTION

In accordance with an aspect of the invention, there is provided a wireless receiving apparatus comprising: a plurality of antennas; a receiving unit configured to receive a plurality of multiple input multiple output-orthogonal frequency division multiplexing (MIMO-OFDM) signals via the antennas; an estimation unit configured to estimate a plurality of channel response values of subcarriers included in the MIMO-OFDM signals; a first computation unit configured to compute an estimated channel-response error common to the subcarriers based on the estimated channel response values; a response correction unit configured to correct the estimated channel response values using the estimated channel-response error; and a second computation unit configured to perform preprocessing for demodulating the MIMO-OFDM signals, using the corrected channel response values.

In accordance with another aspect of the invention, there is provided a wireless receiving apparatus comprising: a plurality of antennas; a receiving unit configured to receive a plurality of multiple input multiple output-orthogonal frequency division multiplexing (MIMO-OFDM) signals via the antennas; an estimation unit configured to estimate a plurality of channel response values of subcarriers included in the MIMO-OFDM signals; a first computation unit configured to perform preprocessing for demodulating the MIMO-OFDM signals, using the channel response values; a second computation unit configured to compute an estimated channel-response error common to the subcarriers based on the estimated channel response values; and a correction unit configured to correct the estimated channel response values using the estimated channel-response error.

### BRIEF DESCRIPTION OF THE SEVERAL VIEWS OF THE DRAWING

FIG. 1 is a block diagram illustrating a transmission apparatus for transmitting signals to wireless receiving apparatus according to embodiments;

FIG. 2 is a block diagram illustrating an apparatus example for generating a signal input to the modulators appearing in FIG. 1;

FIG. 3 is a block diagram illustrating an apparatus example for generating a signal input to the modulators appearing in FIG. 1;

FIG. 4 is a block diagram illustrating an apparatus example for generating a signal input to the modulators appearing in FIG. 1;

FIG. 5 is a block diagram illustrating an apparatus example for generating a signal input to the modulators appearing in FIG. 1;

FIG. 6 is a block diagram illustrating an apparatus example for generating a signal input to the modulators appearing in FIG. 1;

FIG. 7 is a block diagram illustrating an apparatus example for generating a signal input to the modulators appearing in FIG. 1;

FIG. 8 is a block diagram illustrating an apparatus example for generating a signal input to the modulators appearing in FIG. 1;

FIG. 9 is a view illustrating an arrangement example of data subcarriers and pilot subcarriers;

FIG. 10 is a view illustrating a frame format example;

FIG. 11 is a block diagram illustrating a wireless receiving apparatus according to a first, second, third, fourth, fifth and ninth embodiments;

FIG. 12 is a flowchart illustrating an operation example of the wireless receiving apparatus of FIG. 11;

FIG. 13 is a block diagram illustrating a modification of the wireless receiving apparatus of FIG. 11;

FIG. 14 is a block diagram illustrating a wireless receiving apparatus according to a sixth, seventh and ninth embodiments;

FIG. 15 is a flowchart illustrating an operation example of the wireless receiving apparatus of FIG. 14;

FIG. 16 is a block diagram illustrating a wireless receiving apparatus according to an eighth embodiment;

FIG. 17 is a block diagram illustrating a wireless receiving apparatus according to a tenth embodiment;

FIG. 18 is a view illustrating channel estimation known signal sequence examples; and

FIG. 19 is a view illustrating other channel estimation known signal sequence examples.

### DETAILED DESCRIPTION OF THE INVENTION

Wireless receiving apparatuses and methods according to embodiments will be described in detail with reference to the accompanying drawings.

The wireless receiving apparatuses of the embodiments can have high channel estimation accuracy and receiving performance, and wireless receiving methods of the embodiments enable the apparatuses to have such high channel estimation accuracy and receiving performance.

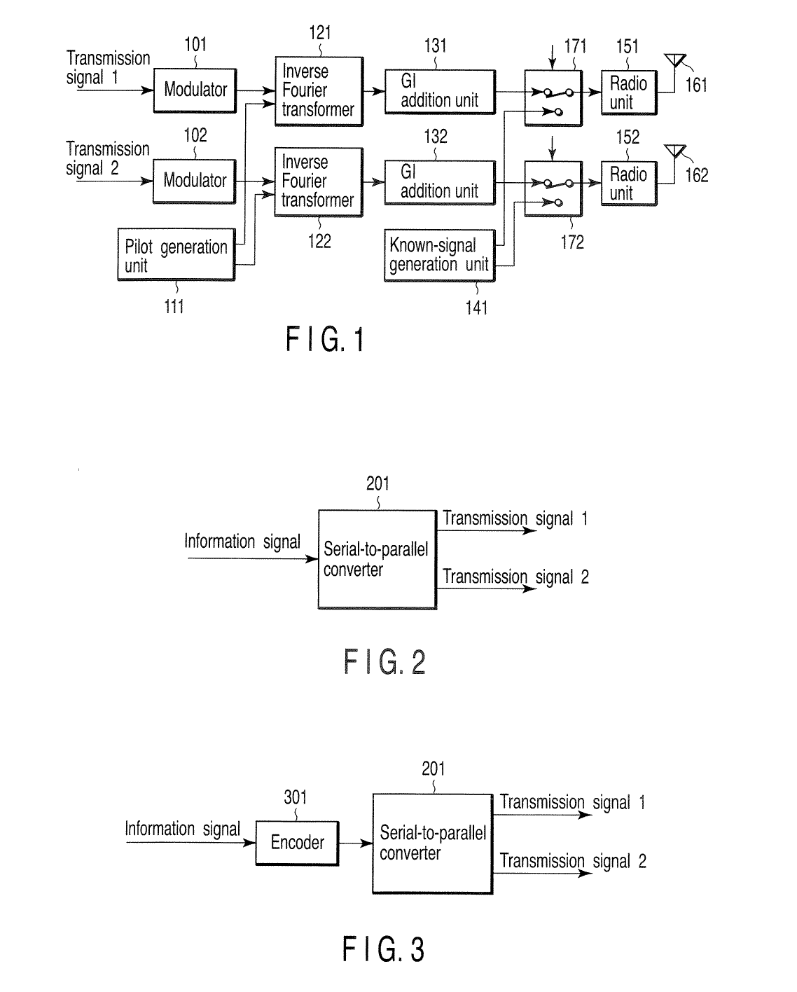

Referring first to FIGS. 1 to 10, a description will be given of a transmission apparatus example for transmitting MIMO-OFDM signals to the wireless receiving apparatuses of the embodiments. FIG. 1 shows an example where two streams are multiplexed.

In the transmission apparatus shown in FIG. 1, a data signal is divided into two streams and then subjected to multiplexing. Namely, a transmission signal 1 as a signal sequence “stream 1”, and a transmission signal 2 as a signal sequence “stream 2” are subjected to, for example, modulation (described later), and then transmitted.

To generate the transmission signals 1 and 2 from a data signal, various means can be contrived. FIG. 2 shows an example of the means, in which a serial-to-parallel converter 201 is used to convert the data signal into parallel signals as the transmission signals 1 and 2. The serial-to-parallel converter 201 may convert the data signal into the parallel signals in units of bits or in units of several bits. The parallel signals may be formed of different numbers of bits according to the modulation orders of the modulation schemes employed in modulators 101 and 102. It is sufficient if the conversion scheme is preset and known to the wireless receiving apparatus.

FIG. 3 shows another scheme of converting a data signal into transmission signals 1 and 2. In this scheme, an encoder 301 performs error correction/coding on the data signal, and then the serial-to-parallel converter 201 divides the resultant signal. Error correction/coding processing degrades the transmission speed of the data signal, since redundancy is imparted to the signal. However, error correction enhances the quality of communication, therefore it is expected that a high throughput characteristic can be acquired.

In the example of FIG. 3, the data signal is encoded by the encoder 301 and then divided into two transmission signals 1 and 2 by the serial-to-parallel converter 201.

The encoder 301 may employ any encoding scheme, such as Reed-Solomon coding, convolutional coding, Turbo coding or Low Density Parity Check coding (LDPC). It is sufficient if the coding scheme is preset and known to the wireless receiving apparatus, and permits the apparatus to perform decoding. Further, a plurality of encoding schemes may be loaded so that an appropriate one of them may be selected in units of frames to be transmitted.

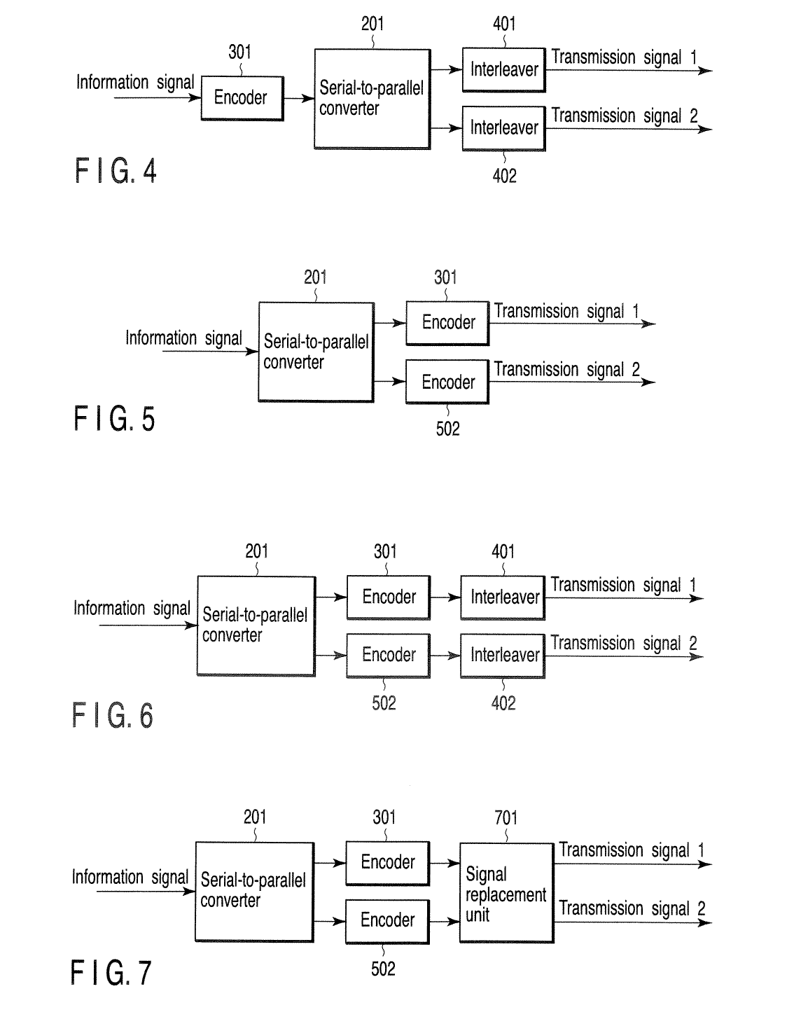

Furthermore, interleavers 401 and 402 as shown in FIG. 4 may be used to rearrange a signal acquired after serial-to-parallel conversion, if the correlation between adjacent codewords included in the signal is high because of the coding scheme employed in the encoder 301. In this case, the interleavers 401 and 402 may perform signal arrangement under any rule. They may perform arrangement under the same rule or different rules. It is sufficient if the rules are preset and known to the wireless receiving apparatus.

Instead of the above-described encoding scheme using only the encoder 301, the signal acquired after serial-to-parallel conversion may be encoded, using two encoders 301 and 502 as shown in FIG. 5. In this case, the encoders 301 and 502 may employ the same encoding scheme or different encoding schemes. Further, they may employ the same encoding scheme and employ different coding rates. It is sufficient if the coding scheme is preset and known to the wireless receiving apparatus.

Yet further, the interleavers 401 and 402 may be added to interleave the components of the signals encoded by the encoders 301 and 502, respectively, as is shown in FIG. 6.

Furthermore, as shown in FIG. 7, a signal replacement unit 701 may be connected to the encoders 301 and 502 to exchange the signals encoded by the encoders 301 and 502, thereby causing the transmission signals 1 and 2 to each contain both of the signals encoded by the encoders 301 and 502. The signal replacement unit 701 may receive signals from the encoders 301 and 502 in units of bits, and output the received signals as the transmission signals 1 and 2 in units of a preset number of bits. Alternatively, the signal replacement unit 701 may receive signals from the encoders 301 and 502 in units of a preset number of bits, and output the received signals as the transmission signals 1 and 2 in units of bits. Yet alternatively, the signal replacement unit 701 may receive signals from the encoders 301 and 502 in units of a preset number of bits, and output the received signals as the transmission signals 1 and 2 in units of a preset number of bits. The signal replacement unit 701 may change the rule of replacement in accordance with the modulation schemes employed in the modulators described later. It is sufficient if the replacement rule is preset and known to the wireless receiving apparatus.

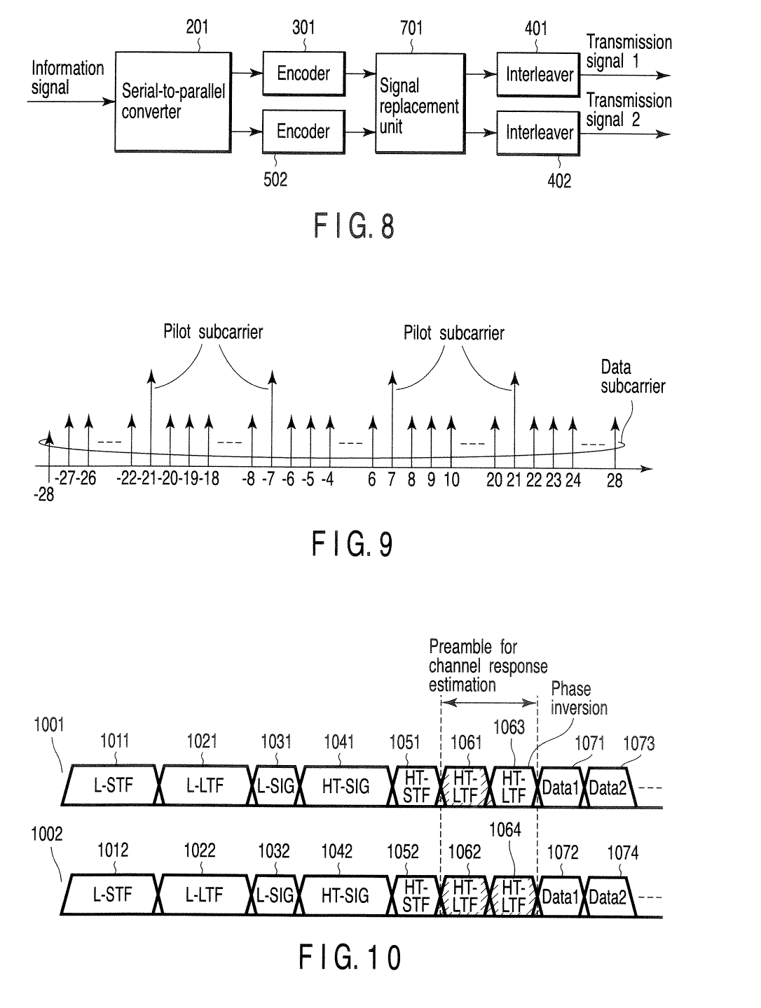

In addition, the interleavers 401 and 402 may be added to further rearrange the components of the signals output from the signal replacement unit 701, as is shown in FIG. 8.

The means for generating two streams, i.e., the transmission signals 1 and 2, is not limited to the above-described one. It is sufficient if the generation means is preset and known to the wireless receiving apparatus.

The thus-generated transmission signals 1 and 2 are sent to the modulators 101 and 102, respectively, where the components of the signals are distributed to subcarriers, and modulation is executed in units of subcarriers. In each of the modulators 101 and 102, the components of the input signals are distributed to the subcarriers in arbitrary order. The components may be assigned to the subcarriers in the frequency-decreasing or -increasing order of the subcarriers, or beginning with a subcarrier of a central frequency. It is sufficient if the order is preset and known to the wireless receiving apparatus.

The modulation scheme employed in units of subcarriers may be any type of modulation scheme, i.e., a phase modulation scheme such as Binary Phase Shift Keying (BPSK) or Quadrature Phase Shift Keying (QPSK), an orthogonal amplitude modulation scheme such as 16 Quadrature Amplitude Modulation (QAM) or 64 QAM, or Differential Phase Shift Keying (DPSK). It is sufficient if the modulation scheme is preset and known to the wireless receiving apparatus, and the apparatus can decode the signals modulated by the modulation scheme.

A pilot generation unit 111 will now be described. The pilot generation unit 111 generates and outputs pilot subcarrier signals for each stream. In general, in OFDM transmission, to correct deviations in local frequency or phase between the transmission apparatus and receiving apparatus, or variations in channel response, a preset number of subcarriers (pilot subcarriers) transmit signals known to the receiving apparatus, and the other subcarriers (data subcarriers) transmit data.

FIG. 9 shows an arrangement example of data subcarriers and pilot subcarriers. In FIG. 9, subcarriers with numbers −21, −7, 7 and 21 are pilot subcarriers. In this example, four subcarriers are used as pilot subcarriers.

In the example of FIG. 9, the subcarriers with numbers −21, −7, 7 and 21 are used as pilot subcarriers. However, the arrangement of pilot subcarriers is not limited to this. Subcarriers of other numbers may be used as pilot subcarriers. It is sufficient if the numbers assigned to pilot subcarriers are preset and known to the wireless receiving apparatus. Further, the number of pilot subcarriers is not limited to four. In the embodiments, it is sufficient if the number of pilot subcarriers is not less than the number of streams.

Assuming here that the signal component of the pilot subcarrier with number k of the m^{th} symbol in stream i (i=1, 2 in the example of FIG. 1) is pᵢ^{(k)}(m), <p^{(k)}(m)> (hereinafter, <A> represents vector A) as a pilot signal vector having the pilot signals of each stream as elements is given by the following equation (1):

p^{(k)}(m)=[p₁^{(k)}(m), p₂^{(k)}(m)]^{T} (1)

where T represents transposition of the matrix.

In the embodiments, the pilot signal vector must satisfy a particular condition. This condition will be described later in a ninth embodiment directed to a channel-response estimation method for estimating error components.

Inverse Fourier transformers 121 and 122 transform, into time-domain signals, the frequency-domain signals generated by the modulators 101 and 102 and pilot generation unit 111. At this time, the means for executing inverse Fourier transform may utilize inverse fast Fourier transform (IFFT), or inverse discrete Fourier transform (IDFT). It is sufficient if the means can convert a frequency-domain signal into a time-domain signal. Further, time-domain signals may be output, cyclically delayed, if the amount of delay is constant between frames. Furthermore, the amount of delay may be varied between frames if this fact is known to the wireless receiving apparatus.

GI addition units 131 and 132 add, in units of OFDM symbols, a signal called a guard interval or cyclic prefix to the time-domain signals output from the inverse Fourier transformers 121 and 122. These signals are generally added in OFDM transmission so as to keep the cycle of each multipath signal and so as not to cause intersymbol interference in the frequency domain, when multipath signals of different propagation delays are received. Since this process is a general one, no detailed description is given thereof.

Signal generation for MIMO-OFDM transmission of a data signal portion in one frame has been described so far. In frame transmission, in general, a header signal is transmitted, as the top of each frame, before a data signal. The header signal includes a signal for synchronization, information necessary for demodulation in a wireless receiving apparatus, such as a modulation scheme, the number of streams, a coding scheme and a coding rate employed for each frame, and preamble signals known to the apparatus for channel response estimation. The header signal is used to make the apparatus compatible with other communication systems. A known-signal generation unit 141 generates the known signals. Switches 171 and 172 perform switching between the data signals output from the GT addition units 131 and 132 and the known signals output from the known-signal generation unit 141, thereby outputting signals as the switching results to radio units 151 and 152, respectively.

FIG. 10 shows a frame format example as an example of the header signal.

In FIG. 10, reference number 1001 denotes the frame format of the stream 1, and reference number 1002 denotes the frame format of the stream 2. Reference numbers 1011, 1012, 1021 and 1022 denote cycle signals for synchronization. Reference numbers 1031, 1032, 1041 and 1042 denote signals that contain information necessary for demodulation, such as the signal length of each frame, the modulation scheme, the coding rate and the number of streams. Reference numbers 1051 and 1052 denote signals used to measure the power for auto gain control (AGC). Reference numbers 1061 to 1064 denote known signals used for channel response estimation. The above signals are included in the header signal. The header signal is followed by data signals 1071 to 1074.

The frame format and the format of the header signal employed in the embodiments are not limited to that shown in FIG. 10. Further, it is not always necessary to include, in the header signal, all the above-mentioned signals for decoding. Other signals may be included in the header signal. It is sufficient if the wireless receiving apparatus can perform decoding.

The radio units 151 and 152 convert, into analog radio frequency signals, the transmission signals generated as described above. The radio units 151 and 152 have a function for converting a digital signal into an analog radio frequency signal having its gain adjusted, and a function for adjusting the gain of an analog radio frequency signal and converting it into a digital signal. For transmission, a digital signal is converted into an analog radio frequency signal.

Since the radio units 151 and 152 are general ones that are formed of an A/D converter, D/A converter, filter, orthogonal modulator, orthogonal demodulator, frequency converter, amplifier, etc., they are not described in detail.

The radio frequency signals generated by the radio units 151 and 152 are sent to transmission antennas 161 and 162, respectively. The transmission antennas 161 and 162 may be of any type, if they can transmit/receive signals of a desired frequency. Further, the transmission antennas 161 and 162 may have the same or different forms, and have the same or different properties.

The transmission signals received by the wireless receiving apparatus according to the embodiments have been described so far. The wireless receiving apparatus itself will now be described in detail.

### First Embodiment

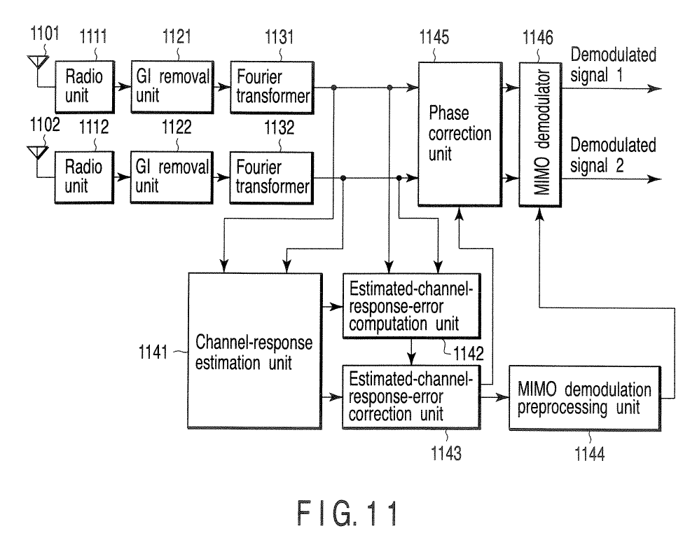

Referring first to FIG. 11, the configuration of the wireless receiving apparatus of a first embodiment will be described. FIG. 11 shows a configuration example of the wireless receiving apparatus according to the first embodiment, in which the number of streams to be multiplexed is 2, and the number of receiving antennas is also 2.

The wireless receiving apparatus of the first embodiment comprises receiving antennas 1101 and 1102, radio units 1111 and 1112, GI removal units 1121 and 1122, Fourier transformers 1131 and 1132, channel-response estimation unit 1141, estimated-channel-response-error computation unit 1142, estimated-channel-response-error correction unit 1143, phase correction unit 1145, MIMO demodulation preprocessing unit 1144 and MIMO demodulator 1146.

The radio units 1111 and 1112 perform radio processing through the receiving antennas 1101 and 1102, respectively, thereby converting radio frequency signals into digital signals. The receiving antennas 1101 and 1102 may be of any type, like the antennas of the transmission apparatus. The same antennas or different antennas may be used between transmission processing and receiving processing. Further, the electrical properties of the antennas may be varied between transmission processing and receiving processing. Any type of antennas may be used if they can receive signals of a desired frequency.

The radio units 1111 and 1112 have the same functions as those of the radio units of the transmission apparatus. In the wireless receiving apparatus, the radio units are used to convert radio frequency signals into digital signals. At this time, each radio frequency signal may be converted once into an intermediate frequency signal and then into a baseband signal. Alternatively, each radio frequency signal may be directly converted into a baseband signal. Orthogonal demodulation may be performed on analog signals, or on digital signals into which intermediate frequency signals are converted by the respective A/D converters, or on digital signals into which the radio frequency signals are directly converted. Any element and/or means may be used if it can convert radio frequency signals into digital signals. The amplifiers, filters, frequency converters or A/D converters incorporated in the radio units 1111 and 1112 are common ones and not essential for the first embodiment. Therefore, they are not described in detail.

The GI removal units 1121 and 1122 remove, from the digital signals output from the radio units 1111 and 1112, GI signals added thereto in the transmission apparatus to prevent intersymbol interference due to multipath.

The Fourier transformers 1131 and 1132 convert, into frequency-domain signals, the time-domain signals from which the IG signals are removed by the GI removal units 1121 and 1122. The Fourier transformers 1131 and 1132 perform discrete Fourier transform. In OFDM transmission, each signal is transmitted using a plurality of subcarriers. The Fourier transformers 1131 and 1132 can extract the original signals transmitted through subcarriers from the signals received, by performing discrete Fourier transform thereon.

Specifically, the Fourier transformers 1131 and 1132 perform discrete Fourier transform on each valid OFDM symbol acquired by removing the IG signals. At this time, the transformers may employ discrete Fourier transform (DFT) or fast Fourier transform (FFT). The signals output from the Fourier transformers 1131 and 1132 will be described later, referring to equations (2) to (11).

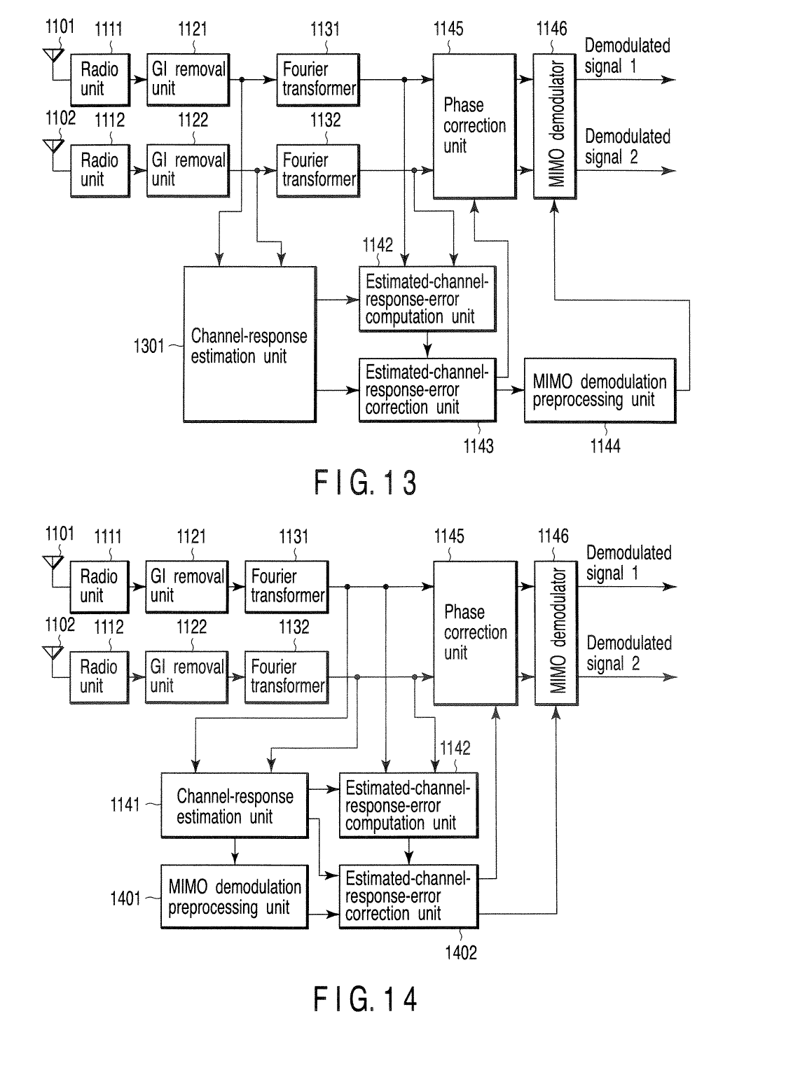

The channel-response estimation unit 1141 estimates a channel response in units of subcarriers. Details of the channel-response estimation unit 1141 will be described later, referring to equations (12) to (19b). A modification (channel estimation unit 1301) of the channel-response estimation unit 1141 will also be described later, referring to FIG. 13 and equations (20) and (21).

The estimated-channel-response-error computation unit 1142 computes an error in the channel response estimated by the channel-response estimation unit 1141. Details of the estimated-channel-response-error computation unit 1142 will be described later, referring to equations (31) to (51).

The estimated-channel-response-error correction unit 1143 corrects an estimated channel-response error corresponding to all subcarriers. Details of the estimated-channel-response-error correction unit 1143 will be described later, referring to equation (52).

The phase correction unit 1145 corrects a phase error in a received signal, using the channel response corrected by the estimated-channel-response-error correction unit 1143. Each received signal has a phase error in units of symbols because of the influence of frequency offset and phase noise. The phase correction unit 1145 corrects a phase error in units of symbols before MIMO demodulation, using the corresponding pilot subcarrier signal component. Details of the phase correction unit 1145 will be described later, referring to equations (53) to (58).

The MIMO demodulation preprocessing unit 1144 performs preprocessing for MIMO demodulation. Specifically, the MIMO demodulation preprocessing unit 1144 performs preprocessing for demodulating each signal MIMO-transmitted through the corresponding data subcarrier, using the corresponding channel response corrected by the estimated-channel-response-error correction unit 1143. Details of the MIMO demodulation preprocessing unit 1144 will be described later in the description after equation (52).

The MIMO demodulator 1146 demodulates each of the spatial multiplexed streams. In this invention, demodulation means that each bit determined to be 0 or 1 is output as a demodulation signal 1 or 2, when no error correction coding is executed by the transmission apparatus, or when hard-decision decoding is executed by the post stage of MIMO demodulator 1146. In contrast, demodulation means that likelihood information, i.e., soft output, concerning each bit is output as a demodulation signal 1 or 2, when soft-decision decoding is executed by the post stage of MIMO demodulator 1146. Since the demodulation scheme of the MIMO demodulator 1146 is irrelevant to the subject matter of the first embodiment, it is not described in detail.

The demodulation signals 1 and 2 output from the MIMO demodulator 1146 are subjected to de-interleaving, signal component switching, decoding, etc., in accordance with the generation scheme employed in the transmission apparatus to generate the transmission signals 1 and 2. Namely, the wireless receiving apparatus of the first embodiment must extract an original information signal from the corresponding received signal, by executing various processes according to those executed by the transmission means of the transmission apparatus. However, since the extraction means is not limited to particular one, no detailed description is given thereof.

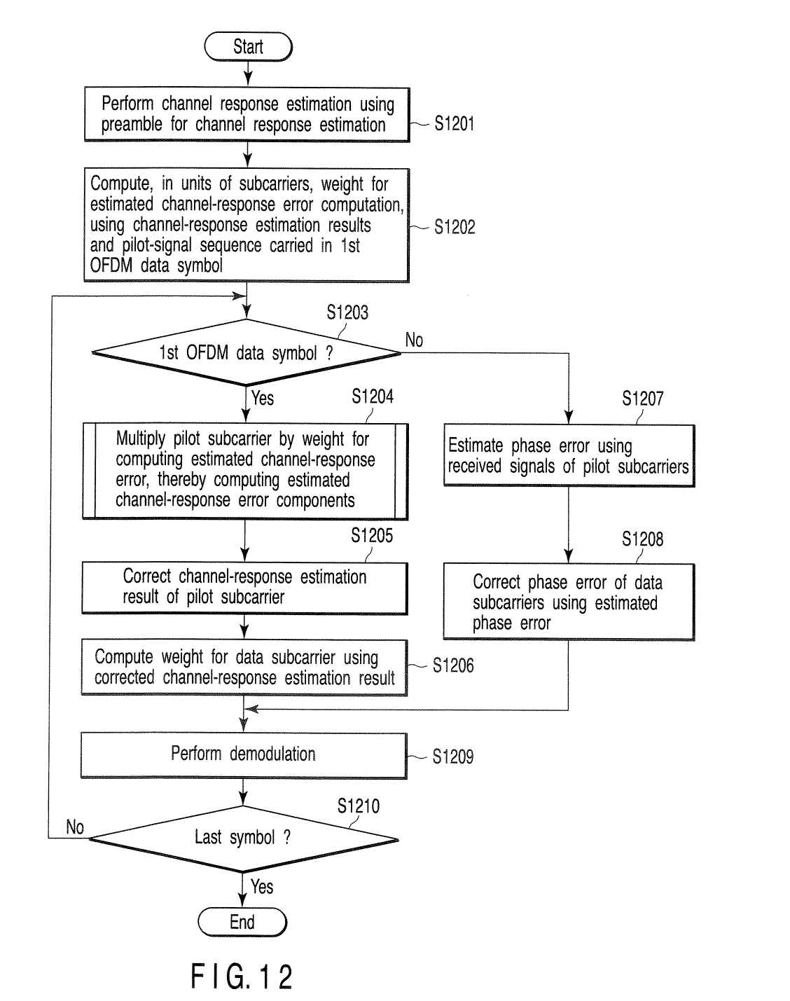

Referring now to FIG. 12, an operation example of the wireless receiving apparatus of FIG. 11 will be described.

The channel-response estimation unit 1141 performs channel response estimation, using a preamble for channel response estimation included in each received signal (see, for example, equation (12)) (step S1201).

The estimated-channel-response-error computation unit 1142 computes a weight for channel response error estimation in units of pilot subcarriers, using the estimated channel response acquired at step S1201, and pilot signal sequences transmitted in, for example, the first OFDM data symbol (see, for example, equations (42) to (45) (step S1202). The pilot signals may not be used in the first data symbol, but may be used in the other symbols.

The estimated-channel-response-error computation unit 1142 determines whether the received symbol is the 1^{st} OFDM symbol of data (step S1203).

If the symbol received at step S1203 is the 1^{st} OFDM symbol of the data, the estimated-channel-response-error computation unit 1142 multiplies the received signals on the pilot subcarriers by the corresponding weights for estimated-channel-response-error computation, thereby computing channel response error components (see, for example, equation (46)) (step S1204).

The estimated-channel-response-error correction unit 1143 receives the estimated-channel-response-error components computed at step S1204, and the channel-response estimation results acquired at step S1201, and corrects the channel-response estimation result of each subcarrier (see, for example, the following equation (52)) (step S1205).

The MIMO demodulation preprocessing unit 1144 performs preprocessing for data subcarrier demodulation, using the channel-response estimation results corrected at step S1205 (step S1206).

On the other hand, if the symbol received at step S1203 is not the 1^{st} OFDM symbol of the data, the phase correction unit 1145 estimates a phase error using the received signal components of the pilot subcarriers of the symbol (step S1207), and corrects the phase error of the data subcarriers of the symbol, using the phase error estimated at step S1207 (step S1208). Concerning steps S1207 and S1208, see the description after equation (53).

After that, the MIMO demodulator 1146 demodulates the multiplexed streams (step S1209). The MIMO demodulator 1146 determines whether the last symbol has been demodulated. If the last symbol has been demodulated, the processing is finished, whereas if the last symbol has not yet been demodulated, the program returns to step S1203 (step S1210).

A description will then be given of a signal output from each Fourier transformer. The signals, transmitted through a multipath channel including paths of different propagation delays, are influenced by frequency selective fading due to delay waves of different propagation delays. As a result, in OFDM transmission, the subcarriers have different channel response values. Similarly, in MIMO-OFDM transmission in which OFDM and MIMO transmission schemes are combined, the subcarriers also have different channel response values. Further, since a plurality of signals are transmitted, spatially multiplexed, the received signal component rᵢ^{(k)}(m) of the k^{th} subcarrier in the m^{th} OFDM symbol output from the i^{th} Fourier transformer is given by the following equation (2):

$${r}_{i}^{( k )} ( m ) = {\sum }_{j = 1}^{D} {h}_{i , j}^{( k )} \cdot {s}_{j}^{( k )} ( m ) + {n}_{i}^{( k )} ( m ) \qquad ( 2 )$$

where h_{i, j}^{(k)} is the channel response of the k^{th} subcarrier of the i^{th} receiving antenna and the j^{th} spatially multiplexed stream, sⱼ^{(k)}(m) is the modulation signal of the k^{th} subcarrier of the j^{th} stream, and nᵢ^{(k)}(m) is the thermal noise of the k^{th} subcarrier. Further, D is the number of streams, and D=2 in the embodiment in which two streams are processed.

Furthermore, received-signal vector <r^{(k)}(m)>, which includes the signal components of the k^{th} subcarriers of the m^{th} OFDM symbols output from the Fourier transformers, is defined by the following equations (3) to (6):

$$\begin{matrix}\begin{matrix}{r}^{( k )} ( m ) = {[ {r}_{1}^{( k )} ( m ) {r}_{2}^{( k )} ( m ) ]}^{T} \\ = {H}^{( k )} {s}^{( k )} ( m ) + {n}^{( k )} ( m )\end{matrix} \\ where , & ( 3 ) \\ {H}^{( k )} = [ \begin{matrix}{h}_{1 , 1}^{( k )} & {h}_{1 , 2}^{( k )} \\ {h}_{2 , 1}^{( k ) f} & {h}_{2 , 2}^{( k )}\end{matrix} ] & ( 4 ) \\ {s}^{( k )} ( m ) = {[ {s}_{1}^{( k )} ( m ) {s}_{2}^{( k )} ( m ) ]}^{T} & ( 5 ) \\ {n}^{( k )} ( m ) = {[ {n}_{1}^{( k )} ( m ) {n}_{2}^{( k )} ( m ) ]}^{T} & ( 6 )\end{matrix}$$

To estimate a modulation signal and also data signal from a received-signal vector as given by the equation (3), it is necessary to estimate, for all subcarriers, channel response matrix H^{(k)} given by the following equation (4).

In wireless communication, in general, to estimate channel response values, signals known to the wireless receiving apparatus are transmitted thereto. If the received-signal vector in the domain, in which known signals are received, is <y^{(k)}(m)>, a known signal to be transmitted by the k^{th} subcarrier in the m^{th} symbol of the j^{th} stream, and the known signal vector of the m^{th} symbol of the k^{th} subcarrier, which includes the known signals of each stream as elements, is <x^{(k)}(m)>, then <y^{(k)}(m)> is given by the following equation (7) as in the equation (2) or (3):

y^{(k)}(m)=H^{(k)}χ^{(k)}(m)+ν^{(k)}(m) (7)

where <v^{(k)}(m)> is the thermal noise vector of the k^{th} subcarrier in the domain in which the known signals are received. Further, a matrix, which uses, as a column vector, the received-signal vector of each symbol in the known-signal-receiving domain, is defined by the following equations (8) to (11):

$$\begin{matrix}[ {y}^{( k )} ( 1 ) {y}^{( k )} ( 2 ) ⋯ ] = {H}^{( k )} \{ {x}^{( k )} ( 1 ) {x}^{( k )} ( 2 ) ⋯ ] + [ {v}^{( k )} ( 1 ) {v}^{( k )} ( 2 ) ⋯ ] \\ {Y}^{( k )} = {H}^{( k )} {X}^{( k )} + {V}^{( k )} \\ where , & ( 8 ) \\ {Y}^{( k )} = [ {y}^{( k )} ( 1 ) {y}^{( k )} ( 2 ) ⋯ ] & ( 9 ) \\ {X}^{( k )} = [ {x}^{( k )} ( 1 ) {x}^{( k )} ( 2 ) ⋯ ] & ( 10 ) \\ {V}^{( k )} = [ {v}^{( k )} ( 1 ) {v}^{( k )} ( 2 ) ⋯ ] & ( 11 )\end{matrix}$$

The channel-response estimation unit 1141 performs channel-response estimation using the above-mentioned signals.

Specifically, the channel-response estimation unit 1141 can perform channel response estimation in units of subcarriers by multiplying the both sides of the equation (8) from the right hand side by the generalized inverse matrix X^{(k)-} of X^{(k)}. Namely, the channel-response estimation unit 1141 computes channel-response matrices using the following equations (12) and (13):

\hat{H}^{(k)}=Y^{(k)}X^{(k)-} (12)

where,

X^{(k)-}=X^{(k)H}(X^{(k)}X^{(k)H})⁻¹ (13)

where H represents complex conjugate transposition.

Further, to realize simple computations and prevent the influence of noise emphasis, the known signals for channel response estimation in MIMO-OFDM transmission may be designed so that the row vectors of X^{(k)} are orthogonal to each other. In this case, generalized inverse matrix X^{(k)-} in the equation (13) is given by the following equation (14):

$$\begin{matrix}{X}^{( k ) -} = {{X}^{( k ) H} ( {X}^{( k )} {X}^{( k ) H} )}^{- 1} \\ = {X}^{( k ) H} ( \frac{1}{E} I ) \\ = \frac{1}{E} \cdot {X}^{( k ) H}\end{matrix} \qquad ( 14 )$$

where E is a value acquired by squiring the norm of each row vector. From this equation, it is understood that when an orthogonal sequence is used, inverse matrix computation is not necessary.

Consideration is given to the frame format shown in FIG. 10 as an example. In the example of FIG. 10, symbols 1061 to 1064 correspond to known symbols for channel response estimation. To enable two streams to be separated, each stream contains two known symbols. Further, among all subcarriers, the symbols 1061, 1062 and 1064 contain the same known signal, and only the symbol 1063 contains the signal acquired by inverting the sign of the known signal. Assuming that the known signal of the k^{th} subcarrier of the symbol 1061 is x₁^{(k)}(1), X^{(k)} is given by the following equation (15):

$${X}^{( k )} = {x}_{1}^{( k )} ( 1 ) [ \begin{matrix}1 & - 1 \\ 1 & 1 \end{matrix} ] \qquad ( 15 )$$

Accordingly, generalized inverse matrix X^{(k)-} is given by the following equation (16), and the channel-response estimation unit 1141 can estimate the channel response matrix based on the following equation (17):

$$\begin{matrix}{X}^{( k ) -} = \frac{1}{2 {x}_{1}^{( k )} ( 1 )} [ \begin{matrix}1 & 1 \\ - 1 & 1 \end{matrix} ] & ( 16 ) \\ {\hat{H}}^{( k )} = \frac{1}{2 {x}_{1}^{( k )} ( 1 )} [ {y}^{( k )} ( 1 ) {y}^{( k )} ( 2 ) ] [ \begin{matrix}1 & 1 \\ - 1 & 1 \end{matrix} ] & ( 17 )\end{matrix}$$

From the matrix, it can be understood that the following equations (18a) and (18b) are the equations for estimating the channel response of each stream, concerning each signal acquired by the Fourier transformer 1131, and that the following equations (19a) and (19b) are the equations for estimating the channel response of each stream, concerning each signal acquired by the Fourier transformer 1132.

$$\begin{matrix}{\hat{h}}_{1 , 1}^{( k )} = \frac{1}{2 {x}_{1}^{( k )} ( 1 )} ( {y}_{1}^{( k )} ( 1 ) - {y}_{1}^{( k )} ( 2 ) ) & ( 18 a ) \\ {\hat{h}}_{1 , 2}^{( k )} = \frac{1}{2 {x}_{1}^{( k )} ( 1 )} ( {y}_{1}^{( k )} ( 1 ) + {y}_{1}^{( k )} ( 2 ) ) & ( 18 b ) \\ {\hat{h}}_{2 , 1}^{( k )} = \frac{1}{2 {x}_{1}^{( k )} ( 1 )} ( {y}_{2}^{( k )} ( 1 ) - {y}_{2}^{( k )} ( 2 ) ) & ( 19 a ) \\ {\hat{h}}_{2 , 2}^{( k )} = \frac{1}{2 {x}_{1}^{( k )} ( 1 )} ( {y}_{2}^{( k )} ( 1 ) + {y}_{2}^{( k )} ( 2 ) ) & ( 19 b )\end{matrix}$$

Thus, the channel response of each subcarrier can be estimated, using simple four fundamental rules of arithmetic in units of outputs of the Fourier transformers. Even if the number of receiving antennas and/or Fourier transformers is increased, it is sufficient if similar processing is added, which is very convenient.

In this embodiment, the case where the sign of symbol 1063 is inverted has been described. However, various schemes can be employed for transmitting known signals for channel response estimation. For instance, the same channel response estimation accuracy can be acquired by inverting the sign of only symbol 1064 instead of symbol 1063. Further, to enhance the resistance against noise, the same symbol may be transmitted several times. The channel-response estimation unit 1141 estimates the channel response using a scheme according to the transmission scheme of to-be-transmitted known symbols.

Furthermore, instead of transmitting, as a preamble signal before a data signal, known signals for channel response estimation using all subcarriers as shown in FIG. 10, a scattered pilot scheme may be employed in which known signals are transmitted during data transmission, using part of the subcarriers, and the subcarriers to be subjected to channel response estimation are sequentially changed from one to another. Also in this scheme, the equation (8) can be established concerning each subcarrier for transmitting known signal components, therefore the same scheme as the above can be employed for each subcarrier to perform channel response estimation.

Yet further, in general, since MIMO-OFDM transmission is designed on the premise of channels of limited delays, the channel response values have correlation between subcarriers. Accordingly, the influence of noise <V^{(k)}> can be suppressed by averaging the channel response values of the subcarriers using an estimated channel response. The channel-response estimation unit 1141 may perform such averaging.

<Modification: Case Where Channel Response Estimation Is Performed Before Fourier Transform>

Referring then to FIG. 13, a description will be given of a case where channel response estimation is performed using the time-domain signals acquired before frequency-domain conversion performed by Fourier transform. The wireless receiving apparatus of FIG. 13 is similar to that of FIG. 11 except for the channel-response estimation unit. In the following description, elements similar to those of FIG. 11 are denoted by corresponding reference numbers, and are not described.

Unlike the case of FIG. 11, the channel-response estimation unit 1301 shown in FIG. 13 performs channel response estimation using the time-domain signals acquired before frequency-domain conversion by Fourier transformers 1131 and 1132.

In the case of using the frame format shown in FIG. 10, when the channel-response estimation unit 1141 estimates the channel response of each subcarrier in the frequency domain, it can estimate only the channel response of a particular stream by computing the sum of two known symbols or difference therebetween using the equations (18a), (18b), (19a) and (19b). Similarly, in channel response estimation in the time domain, only the stream 1 can be extracted by detecting the difference between the levels of two known symbols, and only the stream 2 can be extracted by detecting the sum of the levels of the two known symbols.

A description will be given of an example where the receiving antenna 1101 receives an analog signal, the radio unit 1111 converts it into a digital signal, the GI removal unit 1121 removes a guard interval signal from the digital signal, and the channel-response estimation unit 1301 estimates the channel response of a stream 1 component included in the resultant digital signal. Assume here that the k^{th} sample signal of the first known symbol for channel response estimation is q₁(k), and the k^{th} sample signal of the second known symbol is q₂(k). As described above, since the stream 1 signal can be extracted from the difference between the two symbols, difference z(k) given by the following equation (20) is computed:

$$z ( k ) = \frac{1}{2} ( {q}_{1} ( k ) - {q}_{2} ( k ) ) \qquad ( 20 )$$

If the k^{th} sample signal included in the time-domain signals acquired by subjecting channel-response estimation known symbol 1061 to inverse Fourier transform is Lp(k), z(k) is given by the following equation (21):

$$z ( k ) = {\sum }_{l = 0}^{L - 1} a ( l ) \cdot Lp ( k - l ) + v ( k ) \qquad ( 21 )$$

where a(l) is the time-domain channel response of the l^{th} path, L is the number of paths, and v(k) is the thermal noise contained in z(k). Further, a(0) to a(L-1) represent the impulse response of the entire channel. The channel-response estimation unit 1301 estimates impulse response a(0) to a(L-1) from the received signals z(k) and known signals Lp(k), and estimates the channel response of each subcarrier by subjecting the impulse response to Fourier transform. Impulse response can be estimated by, for example, the least square method or minimum mean square error method. Further, the estimated impulse response may be Fourier-transformed using FFT or DFT, and be transformed by the Fourier transformers 1131 and 1132.

Thus, various schemes (methods) can be used to estimate the channel response of each subcarrier. In the embodiment, any scheme (method) can be employed. The channel response of each subcarrier can be estimated by applying the above-described estimation scheme (method) to all stream components received by each receiving antenna.

As described above, the channel-response estimation unit 1141 or 1301 can estimate the channel response values of all stream components output from each Fourier transformer.

<Influence of Phase Rotations upon Channel Response Estimation>

Other problems still exist. As described above, the transmission apparatus uses a sine-wave signal, occurring therein, to convert a to-be-transmitted baseband signal into a radio frequency signal, while the wireless receiving apparatus uses a sine-wave signal, occurring in the radio unit, to convert a received radio frequency signal into a baseband signal. It is very difficult for both the apparatuses to accurately generate sine-wave signals of a single frequency. Further, since the oscillator of the radio unit contains phase noise that causes variations in frequency, it is difficult to generate the exactly same frequency even if auto frequency control (AFC) is utilized. This difficulty may well cause frequency offset between the transmission and receiving apparatuses, which is a significant factor of degrading the quality of communication. Waveform distortion due to frequency offset and phase noise appears in the form of interference between subcarriers and phase rotation in the entire OFDM symbol. In general, since phase rotation in the entire OFDM symbol is a greater degradation factor than interference between subcarriers, known signals are transmitted using part of the subcarriers and processing for correcting the phase rotation is performed in OFDM transmission.

Consideration will now be given to an estimated channel-response error due to phase rotation caused by frequency offset and phase noise. Since the signals, given by the equation (7), in the domain in which known signals for channel response estimation are received are influenced by phase rotation, they can be expressed by the following equation (22).

y^{(k)}(m)=e^{jφm}H^{(k)}χ^{(k)}(m)+ν^{(k)}(m) (22)

where φₘ is the phase error assumed when the m^{th} known symbol is received. Since a received-signal matrix, which includes, as column vectors, received-signal vectors in the known-signal receiving domain given by the equation (8), undergoes different phase rotations between the columns, it is given by the following equation (23):

Y^{(k)}=H^{(k)}X^{(k)}diag [e^{jφ}^{₁} e^{jφ}^{₂} . . . ]+V^{(k)} (23)

where diag [ ] represents a diagonal matrix including, as diagonal components, a character sequence in parentheses [ ].

When the channel-response estimation unit 1141 or 1301 performs channel response estimation on the above-mentioned signals using the equation (12), the estimated channel response values are given by the following equations (24) and (25):

$$\begin{matrix}\begin{matrix}{\hat{H}}^{( k )} = {Y}^{( k )} {X}^{( k ) -} \\ ≃ {H}^{( k )} {X}^{( k )} diag [ {e}^{{jφ}_{1}} {e}^{{jφ}_{2}} ⋯ ] {X}^{( k ) -} \\ = {H}^{( k )} Φ\end{matrix} \\ where , & ( 24 ) \\ Φ = {X}^{( k )} diag [ {e}^{{jφ}_{1}} {e}^{{jφ}_{2}} ⋯ ] {X}^{( k ) -} & ( 25 )\end{matrix}$$

The equation (24) provides ideal values acquired by channel response estimation when the noise term is ignored.

Thus, the channel-response estimation results contain an estimated error related to a sequence of known channel-response estimation symbols. Consideration will now be given to distortion in channel response estimation, using the frame format of FIG. 10 as an example. When identical signal sequences are transmitted with some symbols made to have different signs, as shown in FIG. 10, the equation (24) can be further developed like the following equation (26), using the known signal x₁^{(k)}(1) of the k^{th} subcarrier of the symbol 1061:

$$\begin{matrix}{\hat{H}}^{( k )} ≃ {H}^{( k )} {X}^{( k )} diag [ {e}^{{jφ}_{1}} {e}^{{jφ}_{2}} ⋯ ] {X}^{( k ) -} \\ = {H}^{( k )} {x}_{1}^{( k )} ( 1 ) Q diag [ {e}^{{jφ}_{1}} {e}^{{jφ}_{2}} ⋯ ] {x}_{1}^{( k ) *} ( 1 ) {{Q}^{H} ( {\vert {x}_{1}^{( k )} ( 1 ) \vert}^{2} {QQ}^{H} )}^{- 1} \\ = {H}^{( k )} Q diag [ {e}^{{jφ}_{1}} {e}^{{jφ}_{2}} ⋯ ] {{Q}^{H} ( {QQ}^{H} )}^{- 1}\end{matrix} \qquad ( 26 )$$

where Q is a matrix indicating a signal sequence that is acquired by eliminating x₁^{(k)}(1) from X^{(k)}, and includes only positive and negative signs as elements. The matrix Q serves as a common matrix between all subcarriers. When the streams employ orthogonal sequences as in the case of FIG. 10, the matrix Q includes rows orthogonal to each other, therefore the equation (26) can be rewritten as the following equations (27) and (28):

$$\begin{matrix}\begin{matrix}{\hat{H}}^{( k )} = {H}^{( k )} Φ \\ = {H}^{( k )} \frac{1}{E} Q diag [ {e}^{{jφ}_{1}} {e}^{{jφ}_{2}} ⋯ ] {Q}^{H}\end{matrix} \\ where , & ( 27 ) \\ Φ = \frac{1}{E} Q diag [ {e}^{{jφ}_{1}} {e}^{{jφ}_{2}} ⋯ ] {Q}^{H} & ( 28 )\end{matrix}$$

From the equations (26) and (27), it can be understood that the channel-response estimation results undergo distortion related to phase errors occurring when known channel-response estimation symbols are received, and the signal sequence Q of known channel-response estimation signals.

In the case of the frame format of FIG. 10, the signal sequences or matrices Q and Φ are given by the following equations (29) and (30):

$$\begin{matrix}Q = [ \begin{matrix}1 & - 1 \\ 1 & 1 \end{matrix} ] & ( 29 ) \\ Φ = \frac{1}{2} [ \begin{matrix}{e}^{{jφ}_{1}} + {e}^{{jφ}_{2}} & {e}^{{jφ}_{1}} - {e}^{{jφ}_{2}} \\ {e}^{{jφ}_{1}} - {e}^{{jφ}_{2}} & {e}^{{jφ}_{1}} + {e}^{{jφ}_{2}}\end{matrix} ] & ( 30 )\end{matrix}$$

From the fact that the non-diagonal components of the matrix Φ have values, it is understood that the estimated channel response contains the channel response of the other stream as an interference component.

The estimated-channel-response-error matrix Φ indicates an estimated error that occurs when channel response estimation is performed on a plurality of symbols in an environment in which frequency offset and phase noise exist. These errors do not occur when a single OFDM symbol is received. Further, from the equations (24) to (28), it is understood that the estimated-channel-response-error matrix Φ is common to all subcarriers.

In the first embodiment, in light of the above features, the estimated-channel-response-error computation unit 1142 computes an estimated channel-response error using the pilot subcarrier signals of data symbols, and the estimated-channel-response-error correction unit 1143 corrects the estimated channel-response error.

A detailed description will be given of the scheme, employed in the estimated-channel-response-error computation unit 1142, of computing an estimated channel-response error using received signals on pilot subcarriers. Assume here that known signals are transmitted using, as pilot subcarriers, four subcarriers with numbers −21, −7, 7 and 21, as is shown in FIG. 9. The received signal component of each pilot subcarrier in the m^{th} OFDM symbol is given by the following equations (31) to (34), based on the equation (1), channel response, estimated channel response and estimated channel-response error:

$$\begin{matrix}\begin{matrix}{r}^{( k )} ( m ) = {e}^{{jψ}_{m}} {H}^{( k )} {p}^{( k )} ( m ) + {n}^{( k )} ( m ) \\ = {e}^{{jψ}_{m}} {\hat{H}}^{( k )} {Φ}^{- 1} {p}^{( k )} ( m ) + {n}^{( k )} ( m ) \\ = {\hat{H}}^{( k )} {P}^{( k )} ( m ) φ + {n}^{( k )} ( m )\end{matrix} \\ where , & ( 31 ) \\ {e}^{{jψ}_{m}} {Φ}^{- 1} = [ \begin{matrix}α & β \\ γ & δ\end{matrix} ] & ( 32 ) \\ φ = {[ α β γ δ ]}^{T} & ( 33 ) \\ {P}^{( k )} ( m ) = [ \begin{matrix}{p}_{1}^{( k )} ( m ) & {p}_{2}^{( k )} ( m ) & 0 & 0 \\ 0 & 0 & {p}_{1}^{( k )} ( m ) & {p}_{2}^{( k )} ( m )\end{matrix} ] & ( 34 )\end{matrix}$$

where Ψₘ is the phase error of the m^{th} OFDM symbol. The to-be-estimated unknown coefficients in the equation (31) are four, i.e., α, β, γ and δ, while the rank of P^{(k)}(m) is 2, which means that only minimal norm solutions exist.

In light of this, estimation is performed using a plurality of pilot subcarriers. Received-signal vector <r^{(k)}(m)> is combined with received-signal vector <r^{(k′)}(m)> in the pilot subcarrier with subcarrier number k′, and vector <r(m)> acquired by increasing the dimension of the vectors is defined by the following equations (35) and (36):

$$\begin{matrix}\begin{matrix}r ( m ) = [ \begin{matrix}{r}^{( k )} ( m ) \\ {r}^{( {k}^{′} )} ( m )\end{matrix} ] \\ = [ \begin{matrix}{\hat{H}}^{( k )} & 0 \\ 0 & {\hat{H}}^{( {k}^{′} )}\end{matrix} ] [ \begin{matrix}{P}^{( k )} ( m ) \\ {P}^{( {k}^{′} )} ( m )\end{matrix} ] φ + [ \begin{matrix}{n }^{( k )} ( m ) \\ {n}^{( {k}^{′} )} ( m )\end{matrix} ] \\ = [ \begin{matrix}{\hat{H}}^{( k )} & 0 \\ 0 & {\hat{H}}^{( {k}^{′} )}\end{matrix} ] P ( m ) φ + [ \begin{matrix}{n }^{( k )} ( m ) \\ {n}^{( {k}^{′} )} ( m )\end{matrix} ]\end{matrix} \\ where , & ( 35 ) \\ \begin{matrix}P ( m ) = [ \begin{matrix}{P}^{( k )} ( m ) \\ {P}^{( {k}^{′} )} ( m )\end{matrix} ] \\ = [ \begin{matrix}{p}_{1}^{( k )} ( m ) & {p}_{2}^{( k )} ( m ) & 0 & 0 \\ 0 & 0 & {p}_{1}^{( k )} ( m ) & {p}_{2}^{( k )} ( m ) \\ {p}_{1}^{( {k}^{′} )} ( m ) & {p}_{2}^{( {k}^{′} )} ( m ) & 0 & 0 \\ 0 & 0 & {p}_{1}^{( {k}^{′} )} ( m ) & {p}_{2}^{( {k}^{′} )} ( m )\end{matrix} ]\end{matrix} & ( 36 )\end{matrix}$$

Consideration will be given to the case where identical signal components extracted from the streams are transmitted using the pilot subcarriers with subcarrier numbers k and k′ (e.g., <p^{(k)}(m)>=[1 1]^{T}, <p^{(k′)}(m)>=[−1 −1]^{T}). In this case, the rank of the two pilot matrices P(m) is 2, and the same problem as occurs when estimation is performed using a single pilot subcarrier.

On the other hand, assume that signals of different signs, extracted from the streams, are transmitted using the pilot subcarriers with subcarrier numbers k and k′ (e.g., <p^{(k)}(m)>=[1 1]^{T}, <p^{(k′)}(m)>=[1 −1]^{T}). In this case, the rank of the two pilot matrices P(m) is 4, and <φ> can be estimated by, for example, the least square method.

As described above, when an estimated channel-response error is computed using pilot subcarriers, the pilot signals must be transmitted so that the rank of the pilot matrix P(m) generated from the pilot matrices of pilot subcarriers used for estimation is equal to 4 (the square of the number of streams).

In the first embodiment, assume that estimation is performed using all pilot subcarriers included in the first data symbol, and that signal components are transmitted by the pilot subcarriers so that the rank of the pilot matrix given by the following equation (37) satisfies the above condition:

$$P ( 1 ) = [ \begin{matrix}{P}^{( - 21 )} ( 1 ) \\ {P}^{( - 7 )} ( 1 ) \\ {P}^{( 7 )} ( 1 ) \\ {P}^{( 21 )} ( 1 )\end{matrix} ] \qquad ( 37 )$$

Note that the pilot subcarriers are arranged in the same way as shown in FIG. 9.

Received-signal vector <r(1)>, which is acquired by combining the received-signal vectors of the pilot subcarriers to increase the vector dimension, is defined by the following equation (38):

$$r ( 1 ) = [ \begin{matrix}{r}^{( - 21 )} ( 1 ) \\ {r}^{( - 7 )} ( 1 ) \\ {r}^{( 7 )} ( 1 ) \\ {r}^{( 21 )} ( 1 )\end{matrix} ] \qquad ( 38 )$$

In this case, the received-signal vector is given by the following equation (39), using the channel response of each subcarrier, the pilot matrix of the pilot subcarriers, and error components in channel response estimation:

$$r ( 1 ) = [ \begin{matrix}{\hat{H}}^{( - 21 )} {P}^{( - 21 )} ( 1 ) \\ {\hat{H}}^{( - 7 )} {P}^{( - 7 )} ( 1 ) \\ {\hat{H}}^{( 7 )} {P}^{( 7 )} ( 1 ) \\ {\hat{H}}^{( 21 )} {P}^{( 21 )} ( 1 )\end{matrix} ] [ \begin{matrix}α \\ β \\ γ \\ δ\end{matrix} ] + [ \begin{matrix}{n}^{( - 21 )} ( 1 ) \\ {n}^{( - 7 )} ( 1 ) \\ {n}^{( 7 )} ( 1 ) \\ {n}^{( 21 )} ( 1 )\end{matrix} ] \qquad ( 39 )$$

From the equation (39), <φ> can be estimated using the least square method (as given by the following equations (40) and (41)):

$$\begin{matrix}φ = {G}^{- 1} [ {P}^{( - 21 ) H} ( 1 ) {\hat{H}}^{( - 21 ) H} {P}^{( - 7 ) H} ( 1 ) {\hat{H}}^{( - 7 ) H} {P}^{( 7 ) H} ( 1 ) {\hat{H}}^{( 7 ) H} {P}^{( 21 ) H} ( 1 ) {\hat{H}}^{( 21 ) H} ] r ( 1 ) \\ where , & ( 40 ) \\ \begin{matrix}{G}^{- 1} = ( {P}^{( - 21 ) H} ( 1 ) {\hat{H}}^{( - 21 ) H} {\hat{H}}^{( - 21 )} {P}^{( - 21 )} ( 1 ) + \\ {P}^{( - 7 ) H} ( 1 ) {\hat{H}}^{( - 7 ) H} {\hat{H}}^{( - 7 )} {P}^{( - 7 )} ( 1 ) + {P}^{( 7 ) H} ( 1 ) {\hat{H}}^{( 7 ) H} {\hat{H}}^{( 7 )} {P}^{( 7 )} ( 1 ) + \\ { {P}^{( 21 ) H} ( 1 ) {\hat{H}}^{( 21 ) H} {\hat{H}}^{( 21 )} {P}^{( 21 )} ( 1 ) )}^{- 1}\end{matrix} & ( 41 )\end{matrix}$$

Accordingly, the estimated-channel-response-error computation unit 1142 computes, for the respective pilot subcarriers, weights for extracting estimated channel-response error components, as given by the following equations (42) to (45), using the channel response values estimated by the channel-response estimation unit 1141 or 1301:

W⁽⁻²¹⁾=G⁻¹P^{(-21)H}(1)Ĥ^{(-21)H} (42)

W⁽⁻⁷⁾=G⁻¹P^{(-7)H}(1)\hat{H}^{(-7)H} (43)

W⁽⁷⁾=G⁻¹P^{(7)H}(1)\hat{H}^{(7)H} (44)

W⁽²¹⁾=G⁻¹P^{(21)H}(1)\hat{H}^{(21)H} (45)

where W^{(k)} (k=−21, −7, 7 and 21) is the weight for the pilot subcarrier with subcarrier number k.

Upon receiving the first data symbol, the estimated-channel-response-error computation unit 1142 multiplies each pilot subcarrier by the corresponding weight (given by the equations (42) to (45)), and sums up the multiplication results to compute estimated channel-response error components α, β, γ and δ based on the following equation (46):

$$φ = {W}^{( - 21 )} {r}^{( - 21 )} ( 1 ) + {W}^{( - 7 )} {r}^{( - 7 )} ( 1 ) + {W}^{( 7 )} {r}^{( 7 )} ( 1 ) + {W}^{( 21 )} {r}^{( 21 )} ( 1 ) \qquad ( 46 )$$

Using the acquired α, β, γ and δ, Φ⁻¹ is acquired based on the equation (32). Thus, the estimated-channel-response-error computation unit 1142 computes an estimated channel-response error due to frequency offset and phase noise.

<Estimated-Channel-Response-Error Computation Unit 1142: Case Where Known Symbols for Channel Response Estimation Are Orthogonal to Each Other>

Consideration will be given to the case where the known symbols for channel response estimation are orthogonal to each other as in the frame format of FIG. 10, and the estimated-channel-response-error matrix Φ is given by the equation (28) or (30). In this case, since the inverse matrix of estimated channel-response error components has equal diagonal terms and equal non-diagonal terms, it can be expressed by the following equation (47):

$${e}^{j {ψ}_{m}} {Φ}^{- 1} = [ \begin{matrix}α & β \\ β & α\end{matrix} ] \qquad ( 47 )$$

Therefore, when an orthogonal sequence is transmitted as a sequence of known signals for channel response estimation, if α and β can be estimated, an estimated channel-response error can be acquired. Accordingly, the equation (33) can be rewritten as the following equation (48):

φ=[α β]^{T} (48)

Consideration will be given to the conditions required for pilot signal components transmitted by pilot subcarriers in such a case as the above. Assume here that pilot signal components, extracted from a particular stream, are transmitted by the pilot subcarriers as expressed by the following equation (49), instead of pilot signal components extracted from all streams:

p^{(k)}(m)=[1 0]^{T} (49)

In this case, the signal component of each pilot subcarrier given by the equation (31) can also be expressed by the following equation (50):

$$\begin{matrix}{r}^{( k )} ( m ) = {\hat{H}}^{( k )} [ \begin{matrix}α & β \\ β & α\end{matrix} ] [ \begin{matrix}1 \\ 0\end{matrix} ] + {n}^{( k )} ( m ) \\ = {\hat{H}}^{( k )} φ + {n}^{( k )} ( m )\end{matrix} \qquad ( 50 )$$

Accordingly, α and β can be estimated using only one pilot subcarrier, based on the estimated channel response matrix H^{(k)}, and Zero-Forcing or Minimum Mean Square Error method.

Consideration will now be given to the case where pilot signal components extracted from all streams are transmitted. Pilot matrix P^{(k)}(m) in the subcarrier with subcarrier number k can be given by the following equation (51):

$${P}^{( k )} ( m ) = [ \begin{matrix}{p}_{1}^{( k )} ( m ) & {p}_{2}^{( k )} ( m ) \\ {p}_{2}^{( k )} ( m ) & {p}_{1}^{( k )} ( m )\end{matrix} ] \qquad ( 51 )$$

Thus, when known signals for channel response estimation are orthogonal to each other, if the rank of the pilot matrix P(m), in which the pilot matrices of all subcarriers are arranged as in the equation (37), is equal to the number of streams, an estimated channel-response error can be given by the equation (40).

As described above, the number of subcarriers required varies in accordance with the transmission scheme of pilot subcarriers. The number of subcarriers necessary for estimation can be classified as follows, depending upon the stream of known symbols for channel response estimation:

(1) When the known symbols for channel response estimation are orthogonal to each other, the number of pilot subcarriers is set to the value that makes the rank of the pilot matrix P(m) equal to the number of streams; and

(2) When the known symbols for channel response estimation are not orthogonal to each other, the number of pilot subcarriers is set to the value that makes the rank of the pilot matrix P(m) equal to the square of the number of streams.

In the above-described scheme for computing an estimated channel-response error, the pilot subcarriers are arranged as shown in FIG. 9, and the number of pilot subcarrier is 4. However, the number of subcarriers in the first embodiment is not limited to 4. Any number of pilot subcarriers and any stream of pilot signals may be employed, if a pilot matrix can be generated from signal components transmitted by each pilot subcarrier, as indicated by the equation (37), and the rank of the generated matrix is not less than the number of streams.

The estimated-channel-response-error correction unit 1143 corrects the channel response of each of the signal-transmitting subcarriers including pilot subcarriers, using e^{jΨ1} Φ⁻¹ computed by the estimated-channel-response-error computation unit 1142.

The relationship given by the equation (24) is established between the channel response matrix Ĥ (the output of the channel-response estimation unit 1141 or 1301) containing an estimated error and the real channel response matrix H (the output of the estimated-channel-response-error correction unit 1143). In light of this, the estimated-channel-response-error correction unit 1143 multiplies, by e^{jΨ1} Φ⁻¹, the estimated channel response of each of all subcarriers, as expressed by the following equation (52), thereby correcting it:

\hat{H}′^{(k)}=e^{jψ1}Ĥ^{(k)}Φ⁻¹ (52)

In the above equation, since the case where an estimated channel-response error is computed using the pilot subcarriers of the first data symbol is assumed, Ψ₁ is multiplied.

<MIMO Demodulation Preprocessing unit 1144>

In the first embodiment, the MIMO demodulation scheme is not limited to any particular scheme. Usable schemes are, for example, a scheme using spatial filtering, such as ZF or MMSE, a scheme, such as Ordered Successive Interference Cancellation (OSIC), in which both spatial filtering and canceller are utilized, a likelihood determination scheme, sphere decoding, K-Best or M-algorithm for reducing the number of computations needed for likelihood determination, and any other scheme. It is sufficient if the schemes can demodulate the signals transmitted by MIMO transmission.

The MIMO demodulation preprocessing unit 1144 performs preprocessing according to MIMO demodulation. For instance, when MIMO demodulation is performed using ZF, the weights to be assigned to all data subcarriers are computed under the ZF scheme, using the channel response values corrected by the estimated-channel-response-error correction unit 1143. Further, metric weight coefficients to be multiplied in units of subcarrier streams are computed. When using sphere decoding or M-algorithm, the channel response values of all data subcarriers are subjected to QR decomposition, using the channel response values corrected by the estimated-channel-response-error correction unit 1143. Alternatively, ZF-scheme weight computation is performed on each data subcarrier, and the product of the corresponding channel response matrix and complex conjugate matrix is subjected to Cholosky decomposition.

As described above, the MIMO demodulation preprocessing unit 1144 performs preprocessing for MIMO demodulation, using the channel response values corrected by the estimated-channel-response-error correction unit 1143. The MIMO demodulation scheme in the first embodiment is not limited to the above-described one, and the process performed by the MIMO demodulation preprocessing unit 1144 is not limited to the above-described one. Further, if any other process necessary for MIMO demodulation exists, it may be employed. In contrast, if any particular process is not needed, it may not be employed. It is sufficient if the signals transmitted by MIMO transmission can be decoded.

<Phase Correction Unit 1145>

Because of the influence of the above-mentioned frequency offset and phase noise, the received signals have different phase errors between symbols. The phase correction unit 1145 corrects a phase error in units of symbols, using the signal component of each pilot subcarrier.

The signal components of the 1^{st} symbol contain a phase error in their error components computed by the estimated-channel-response-error computation unit 1142, and the estimated-channel-response-error correction unit 1143 corrects channel response values. Therefore, it is not necessary to correct the 1^{st} symbol. The second et seq. symbols should be corrected.

Since data symbols also contain phase errors, the received-signal vector given by the equation (3) can also be expressed as the following equation (53), which is similar to the equation (22):

r^{(k)}(m)=e^{jψm}H^{(k)}s^{(k)}(m)+n^{(k)}(m) (53)

Note that signals transmitted by pilot subcarriers are known to the wireless receiving apparatus, and therefore replica signals can be given by the following equation (54):

r̅^{(k)}(m)=\hat{H}′^{(k)}p^{(k)}(m) (54)

The inner product of the complex conjugate vector of a replica signal corresponding to a pilot signal, and a received-signal vector is given by the following equation (55):

$${\tilde{r}}^{( k ) H} ( m ) {r}^{( k )} ( m ) = {e}^{j {ψ}_{m}} ( {p}^{( k ) H} ( m ) {\hat{H}}^{′ ( k ) H} {H}^{( k )} {p}^{( k )} ( m ) ) + {\tilde{r}}^{( k ) H} {n}^{( k )} ( m ) \qquad ( 55 )$$

Assuming that the estimated-channel-response-error correction unit 1143 correctly corrects channel response values, the first term in parentheses, included in the right hand side of the equation (55), is of Hermitian form, therefore is a real number. Further, assuming that the noise component as the second term of the right hand side can be ignored, the equation (55) can be rewritten as the following expressions (56) and (57):

$$\begin{matrix}{\tilde{r}}^{( k ) H} ( m ) {r}^{( k )} ( m ) ≃ {a}^{( k )} ( m ) \cdot {e}^{j {ψ}_{m}} \\ where , & ( 56 ) \\ \begin{matrix}{a}^{( k )} ( m ) = ( {p}^{( k ) H} ( m ) {\hat{H}}^{′ ( k ) H} {H}^{( k )} {p}^{( k )} ( m ) ) \\ = {e}^{- j {ψ}_{1}} ( {p}^{( k ) H} ( m ) {H}^{( k ) H} {H}^{( k )} {p}^{( k )} ( m ) )\end{matrix} & ( 57 )\end{matrix}$$

Since a^{(k)}(m) is acquired by multiplying a real number by the reverse characteristic of the phase error of the 1^{st} symbol, the phase error of the m^{th} symbol based on the phase error of the 1^{st} symbol can be estimated by acquiring the argument of the expression (56). Since the phase of each subcarrier is adjusted to the phase error of the 1^{st} symbol by correcting the estimated channel-response error, each received signal can be adjusted to the reference phase of the corresponding estimated channel response by acquiring a phase error based on the phase error of the 1^{st} symbol.

Thus, phase error estimation can be performed using only one pilot subcarrier. However, to reduce the influence of noise, it may be performed using a plurality of pilot subcarriers. When the number and arrangement of pilot subcarriers are set as shown in FIG. 9, phase error estimation can be achieved using the pilot subcarriers and following equation (58):

$${\hat{ψ}}_{m}^{′} = arg ( {\tilde{r}}^{( - 21 ) H} ( m ) {r}^{( - 21 )} ( m ) + {\tilde{r}}^{( - 7 ) H} ( m ) {r}^{( - 7 )} ( m ) + {\tilde{r}}^{( 7 ) H} ( m ) {r}^{( 7 )} ( m ) + {\tilde{r}}^{( 21 ) H} ( m ) {r}^{( 21 )} ( m ) ) \qquad ( 58 )$$

where arg ( ) is the argument of ( ), Ψ′ₘ is the phase error of the m^{th} symbol based on the phase error of the 1^{st} symbol.

As described above, the phase correction unit 1145 performs phase error correction by multiplying each of all data subcarriers by the reverse characteristic of the estimated phase error.

Although the scheme of performing estimation using a single pilot subcarrier, and the scheme of performing estimation using all pilot subcarriers have been described, the embodiment is not limited to this. Two or three pilot subcarriers may be used for estimation. Estimation can be realized if the number of terms to be summed up in the equation (58) is set equal to the number of pilot subcarriers used for estimation.

Further, although the scheme of performing phase error estimation by generating replica signals has been described, the phase error of each symbol can be estimated even by acquiring the difference in level between two successive symbols as indicated by the following equation (59), when a certain pilot transmission scheme is employed:

\hat{ψ}ₘ¹=\hat{ψ}ₘ₋₁¹+arg(r^{(k)H}(m−1)r^{(k)}(m)) (59)

Thus, the phase correction unit 1145 may estimate the phase error of each symbol from the difference in level between two successive symbols. Alternatively, phase error estimation may be performed by recursively adding the inner product of a received signal and a previously estimated phase error or replica signal, using a forgetting coefficient.

The received signal having its phase error corrected by the phase correction unit 1145 is sent to the MIMO demodulator 1146, where it is subjected to MIMO demodulation using, for example, a weight processed by the MIMO demodulation preprocessing unit 1144.

As described above concerning the MIMO demodulation preprocessing unit 1144, the MIMO demodulator 1146 is not limited to any particular scheme. It is sufficient if it can demodulate MIMO-transmitted signals.

As described above, in the first embodiment, the estimated channel-response error due to frequency offset and phase noise can be corrected, thereby realizing MIMO demodulation of high accuracy.

### Second Embodiment

A wireless receiving apparatus according to a second embodiment has the same configuration as that of the first embodiment shown in FIGS. 11 or 13, and is similar to the latter in that an estimated channel-response error, caused by the frequency offset between the transmission apparatus and wireless receiving apparatus and phase noise resulting therefrom, is corrected using pilot subcarriers.

The second embodiment differs from the first embodiment in the scheme of computing a weight in units of pilot subcarriers to acquire an estimated channel-response error. Specifically, they employ different weight computation methods for the estimated-channel-response-error computation unit 1142. In the first embodiment, a weight is computed in units of pilot subcarriers using the equations (42) to (45). This method involves no problems if the signal-to-noise ratio (SNR) is high, and signal power is sufficiently higher than noise power. However, if SNR is low, noise may be emphasized depending upon the channel response of each pilot subcarrier. The second embodiment provides weights for preventing noise from being emphasized, and enabling distortion of channel response estimation to be estimated at high accuracy even in low SNR regions.

<Computation of Weights>

A description will now be given of the details of weights and a weight computation method.

In the second embodiment, weights are computed based on the MMSE scheme, since noise may well be emphasized if weights are computed based on the ZF scheme as in the first embodiment. Firstly, consideration will be given to the weights based on the MMSE scheme and used to extract transmitted pilot signal components, instead of extracting estimated channel-response components. In this case, one of the two methods can be employed—one method for computing, to acquire weights, the self-correlation matrix of received signal components, and the cross-correlation matrix of the received signal components and reference signal components; the other method for computing Wiener solutions by approximation from estimated channel response values.

At first, the method using the self-correlation matrix and cross-correlation matrix will be described.

If the weight for extracting the signal component of the pilot subcarrier with subcarrier number k is set as Wₚ^{(k)}, the weights based on the MMSE scheme are given by the following equations (60), (61) and (62):

Wₚ^{(k)}=R_{yy}^{(k)-1}R_{yχ}^{(k)} (60)

where,

R_{yy}^{(k)}=E[y^{(k)}(m)y^{(k)H}(m)] (61)

R_{yχ}^{(k)}=E[y^{(k)}(m)χ^{(k)H}(m)] (62)

where E[ ] represents ensemble averaging. In the frame format example shown in FIG. 10, two known symbols for channel response estimation are transmitted. Therefore, concerning the example of FIG. 10, the equations (61) and (62) can be rewritten as the following equations (63) and (64), respectively, using the two symbols:

$$\begin{matrix}{R}_{yy}^{( k )} = \frac{1}{2} {\sum }_{m = 1}^{2} {y}^{( k )} ( m ) {y}^{( k ) H} ( m ) & ( 63 ) \\ {R}_{yx}^{( k )} = \frac{1}{2} {\sum }_{m = 1}^{2} {y}^{( k )} ( m ) {x}^{( k ) H} ( m ) & ( 64 )\end{matrix}$$

If the equation (60) is solved using the equations (63) and (64), MMSE-scheme weights for extracting pilot signals can be acquired. In this case, the simple average of two known symbols in the channel-response-estimation known-symbol receiving domain is acquired. However, averaging may be performed by performing weighted summation on each symbol. Further, in this case, weights are acquired by directly computing the cross-correlation matrix of a limited number of symbols. However, weights may be computed by successive updating based on the Least Mean Square (LMS) method or Recursive Least Square (RLS) method.

Weights can also be computed using Wiener solutions. As a result of ensemble averaging in the equations (61) and (62), their correlation matrices can be expressed by the following equations (65), (66) and (67):

R_{yy}^{(k)}=Ĥ^{(k)}Ĥ^{(k)H}+Rₙₙ (65)

R_{yχ}^{(k)}=Ĥ^{(k)} (66)

where,

Rₙₙ=diag [σ₁² σ₂²] (67)

where Rₙₙ is the diagonal matrix of the levels, as diagonal terms, of thermal noise power contained in signals output from the radio units, and σ₁² and σ₂² are thermal noise power levels contained in the outputs of the radio units 1111 and 1112, respectively.

From the equation (65), it is understood that noise power must be estimated to acquire MMSE-scheme weights when the present method is used. Various noise-power estimation methods corresponding to various frame formats are possible. In the frame format example of FIG. 10, since the symbols 1011, 1012, 1021 and 1022 are cyclic signals, only noise signals can be extracted by computing the differences between the symbols in accordance with the cycles, and noise power can be directly computed from the extracted noise signals. Further, replica signals (replica signal components) are generated using the demodulation results of the symbols 1031 and 1032 or symbols 1041 and 1042, and are subtracted from received signals (received signal components) to thereby extract only noise signals, thereby estimating noise power. Thus, various noise-power estimation methods corresponding to various frame formats are possible, and any one of the methods may be employed for noise-power estimation in the second embodiment. One of the above-described two methods may be employed, or a method quite different from them may be employed. It is sufficient if noise power can be estimated.

When the weights to be assigned to the signal components in the frame format of FIG. 10 are computed using the equations (65) and (66), they are given by the following equation (68):

$$\begin{matrix}{W}_{p}^{( k )} = {( {\hat{H}}^{( k )} {\hat{H}}^{( k ) H} + {R}_{nn} )}^{- 1} {\hat{H}}^{( k )} \\ = {( {H}^{( k )} Φ {Φ}^{H} {H}^{( k ) H} + {R}_{nn} )}^{- 1} {H}^{( k )} Φ\end{matrix} \qquad ( 68 )$$

Further, in the frame format of FIG. 10, since the equations (28), (29) and (30) are established, Φ is a matrix acquired by multiplying a unitary matrix by scalars, and the equation (68) can be expanded as the following equation (69):

Wₚ^{(k)}=(H^{(k)}H^{(k)H}+Rₙₙ)⁻¹ G^{(k)Φ} (69)

Each weight as given by the equation (69) is acquired by multiplying, by Φ from the right hand side, the weight acquired when the channel response corresponding to each weight contains no distortion, and the signal component of the pilot subcarrier extracted using this weight is given by the following equation (70):

Wₚ^{(k)H}r^{(k)}(m)≃φₘΦ⁻¹p^{(k)}(m) (70)

As a result, when the rank of the pilot matrix given by the equation (37) is not less than the number of streams, the estimated-channel-response-error computation unit 1142 can compute estimated channel-response error components as given by the equation (47), using the received signal components of pilot subcarriers, as in the first embodiment.

Further, unlike the first embodiment, unnecessary signal components contained in the signal components, which are extracted by multiplying weights as shown in the equation (70), have correlation. Since subcarriers have different channel response values, the unnecessary signal components after weight multiplication have different power levels. Accordingly, even if the signal components of pilot subcarriers acquired after weighting processing are combined as shown in the equation (35) or (39) and subjected to the least square method, highly accurate estimation cannot be executed because of the influence of the unnecessary signal components.

In light of the above, consideration will be given to the application of the generalized least square method to the signal components of pilot subcarriers acquired after weight application, using a correlation matrix of unnecessary signal components. It is known that a correlation matrix Rₑₑ^{(k)} of unnecessary signal components acquired when the MMSE scheme is employed is given by the following equation (71):

Rₑₑ^{(k)}=I−Wₚ^{(k)H}H^{(k)} (71)

where I is a unit matrix having a dimension equal to the number of streams. The correlation matrix of unnecessary signal components given by the equation (71) is adversely affected by distortion occurring in channel response estimation. When the equation (71) is solved using the weights and channel responses computed as the above, it is understood from the following equation (72) that the correlation matrix Rₑₑ^{(k)} is influenced by the estimated channel-response error matrix Φ:

$$\begin{matrix}{R}_{ee}^{( k )} = I - {W}_{p}^{( k ) H} {\hat{H}}^{( k )} \\ = I - {W}_{p}^{( k ) H} {H}^{( k )} Φ\end{matrix} \qquad ( 72 )$$

In the generalized least square method, <φ> given by the equation (33) or (48) is estimated based on the following equation (73), using the pilot matrix with subcarrier number k given by the equation (34) or (51):

$$φ = {( {P}^{( k ) H} ( m ) {R}_{ee}^{( k ) - 1} {P}^{( k )} ( m ) )}^{- 1} {P}^{( k ) H} {R}_{ee}^{( k ) - 1} ( {W}_{p}^{( k ) H} {r}^{( k )} ( m ) ) \qquad ( 73 )$$

When the rank of P^{(k)}(m) is equal to the number of streams, estimation can be performed using only one subcarrier signal as described above. However, if the rank is less than that, estimation can be performed by vector dimension extension, in which pilot subcarrier signal components acquired after weighting processing are combined as in the equation (38). In this case, if estimation is performed based on the generalized least square method expressed by the equation (73), estimation can be performed as given by the following equations (74) and (75):

$$\begin{matrix}φ = {( {P}^{H} ( m ) {R}_{ee}^{- 1} P ( m ) )}^{- 1} {P}^{H} ( m ) {R}_{ee}^{- 1} [ \begin{matrix}{W}_{p}^{( - 21 ) H} {r}^{( - 21 )} ( m ) \\ {W}_{p}^{( - 7 ) H} {r}^{( - 7 )} ( m ) \\ {W}_{p}^{( 7 ) H} {r}^{( 7 )} ( m ) \\ {W}_{p}^{( 21 ) H} {r}^{( 21 )} ( m )\end{matrix} ] \\ where , & ( 74 ) \\ {R}_{ee}^{- 1} = [ \begin{matrix}{( {R}_{ee}^{( - 21 )} )}^{- 1} & & & \\ & {( {R}_{ee}^{( - 7 )} )}^{- 1} & & \\ & & {( {R}_{ee}^{( 7 )} )}^{- 1} & \\ & & & {( {R}_{ee}^{( 21 )} )}^{- 1}\end{matrix} ] & ( 75 )\end{matrix}$$

Consideration will now be given to the inverse matrix of the correlation matrix of unnecessary signal components. If inverse matrix lemma is utilized, the equation (72) concerning the correlation matrix of unnecessary signal components can be developed as the following equation (76):

$$\begin{matrix}{R}_{ee}^{( k ) - 1} = {( I - {W}_{p}^{( k ) H} {H}^{( k )} Φ )}^{- 1} \\ = I + {{W}_{p}^{( k ) H} ( I - {H}^{( k )} Φ {W}_{p}^{( k ) H} )}^{- 1} {H}^{( k )} Φ \\ = I + {W}_{p}^{( k ) H} [ I - {H}^{( k )} {ΦΦ}^{H} {H}^{( k ) H} \\ { {( {H}^{( k )} {ΦΦ}^{H} {H}^{( k ) H} + {R}_{nn} )}^{- 1} ]}^{- 1} {H}^{( k )} Φ \\ = I + {Φ}^{H} {H}^{( k ) H} ( {H}^{( k )} {ΦΦ}^{H} {H}^{( k ) H} + \\ { {R}_{nn} - {H}^{( k )} {ΦΦ}^{H} {H}^{( k ) H} )}^{- 1} {H}^{( k )} Φ \\ = I + {Φ}^{H} {H}^{( k ) H} {R}_{nn}^{- 1} {H}^{( k )} Φ\end{matrix} \qquad ( 76 )$$

Similarly, the equation (68) concerning the weight matrix can be rewritten as the following equation (77), if inverse matrix lemma is utilized:

$$\begin{matrix}{W}_{p}^{( k )} = {( {H}^{( k )} {ΦΦ}^{H} {H}^{( k ) H} + {R}_{nn} )}^{- 1} {H}^{( k )} Φ \\ = {R}_{nn}^{- 1} {H}^{( k )} {Φ ( I + {Φ}^{H} {H}^{( k ) H} {R}_{nn}^{- 1} {H}^{( k )} Φ )}^{- 1} \\ = {R}_{nn}^{- 1} {H}^{( k )} {ΦR}_{ee}^{( k )}\end{matrix} \qquad ( 77 )$$

Using the equations (76) and (77), the equation (74) is rewritten as the following equations (78) and (79):

$$\begin{matrix}φ = {G}^{- 1} [ {P}^{( - 21 ) H} ( 1 ) {\hat{H}}^{( - 21 ) H} {R}_{nn}^{- 1} {P}^{( - 7 ) H} ( 1 ) {\hat{H}}^{( - 7 ) H} {R}_{nn}^{- 1} {P}^{( 7 ) H} ( 1 ) {\hat{H}}^{( 7 ) H} {R}_{nn}^{- 1} {P}^{( 21 ) H} ( 1 ) {\hat{H}}^{( 21 ) H} {R}_{nn}^{- 1} ] r ( 1 ) & ( 78 ) \\ where , & \\ {G}^{- 1} = {( \begin{matrix}{P}^{( - 21 ) H} ( 1 ) ( I + {\hat{H}}^{( - 21 ) H} {R}_{nn}^{- 1} {\hat{H}}^{( - 21 )} ) {P}^{( - 21 )} ( 1 ) + \\ {P}^{( - 7 ) H} ( 1 ) ( I + {\hat{H}}^{( - 7 ) H} {R}_{nn}^{- 1} {\hat{H}}^{( - 7 )} ) {P}^{( - 7 )} ( 1 ) + \\ {P}^{( 7 ) H} ( 1 ) ( I + {\hat{H}}^{( 7 ) H} {R}_{nn}^{- 1} {\hat{H}}^{( 7 )} ) {P}^{( 7 )} ( 1 ) + \\ {P}^{( 21 ) H} ( 1 ) ( I + {\hat{H}}^{( 21 ) H} {R}_{nn}^{- 1} {\hat{H}}^{( 21 )} ) {P}^{( 21 )} ( 1 )\end{matrix} )}^{- 1} & ( 79 )\end{matrix}$$

Thus, also in the second embodiment, a weight for extracting an estimated channel-response error is computed in units of pilot subcarriers, the first data symbol is multiplied by the computed weights, and the sum of all subcarriers is computed, thereby estimating the distortion component that occurs in channel response estimation. The weights of the subcarriers can be given by the following equations (80) to (83) that are similar to the equations (42) to (45) used in the first embodiment:

W⁽⁻²¹⁾=G⁻¹P^{(-21)H}(1)Ĥ^{(-21)H}Rₙₙ⁻¹ (80)

W⁽⁻⁷⁾=G^{31 1}P^{(-7)H}(1)\hat{H}^{(-7)H}Rₙₙ⁻¹ (81)

W⁽⁻⁷⁾=G⁻¹P^{(7)H}(1)\hat{H}^{(7)H}Rₙₙ⁻¹ (82)

W⁽²¹⁾=G⁻¹P^{(21)H}(1)\hat{H}^{(21)H}Rₙₙ⁻¹ (83)

This means that the weights of pilot subcarriers for extracting an estimated channel-response error, employed in the second embodiment, can be given by the equations quite similar to those employed in the first embodiment. The weights in the first and second embodiments differ only in the method of computing the first inverse matrix G⁻¹. The equation (78) employed in the second embodiment contains the inverse matrix of the correlation matrix of noise components, which prevents noise emphasis. This is the only one point differing from the equation (40) employed in the first embodiment. The other processes performed in the second embodiment are identical to those of the first embodiment. Namely, using the channel-response estimation results of the channel-response estimation unit 1141, the estimated-channel-response-error computation unit 1142 computes noise power, solves the weight equations (80) to (83) corresponding to the respective pilot subcarriers, based on the pilot signal components of the 1^{st} symbol, and multiplies the pilot subcarriers of the 1^{st} symbol by the respective resultant weights. The weighted pilot-subcarrier signal components are combined to compute the estimated channel-response error components α and β to thereby acquire Φ⁻¹.

No detailed description is given of the method of correcting estimated channel-response values by the estimated-channel-response-error correction unit 1143 using Φ⁻¹ estimated as the above, and the operations of the MIMO demodulation preprocessing unit 1144, phase correction unit 1145 and MIMO demodulator 1146, since they are identical to those of the first embodiment.

As described above, the second embodiment can correct an estimated channel-response error due to frequency offset and phase noise, and hence realize highly accurate MIMO demodulation. If the estimated channel-response error is computed in light of noise power, the emphasis of noise can be prevented even in low SNR regions, thereby realizing further highly accurate MIMO demodulation.

### Third Embodiment

A wireless receiving apparatus according to a third embodiment has the same configuration as that of the first or second embodiment shown in FIGS. 11 or 13, and is similar to the first or second embodiment in that an estimated channel-response error, caused by the frequency offset between the transmission apparatus and wireless receiving apparatus and phase noise resulting therefrom, is corrected using pilot subcarriers.

The third embodiment differs from the first or second embodiment in the scheme of computing a weight in units of pilot subcarriers to acquire an estimated channel-response error. Specifically, they employ different weight computation methods for the estimated-channel-response-error computation unit 1142.

In the first and second embodiments, a weight is computed in units of pilot subcarriers using the equations (42) to (45) and the equations (80) to (83), respectively. These methods utilize common inverse matrix G⁻¹ for all subcarriers, and hence reduce the load on inverse matrix computation. However, the channel response values of all subcarriers used for estimation are needed, therefore weight computation is performed only after the channel response values of all subcarriers are determined. As a result, processing delay may occur.

In light of the above problem, the third embodiment provides a scheme for preventing such processing delay, wherein each weight, assigned to the corresponding subcarrier and used for computing an estimated channel-response error, is computed without the channel response values of the subcarriers other than the corresponding subcarrier.

The operation of the estimated-channel-response-error computation unit 1142 performed in the third embodiment will be described.

When as in the equation (70), the received signal components of pilot subcarriers are multiplied by MMSE-scheme weights given by the equation (60), the product of the inverse matrix of transmission signal components and estimated channel-response error components can be extracted.

A matrix, which uses, as column vectors, signal vectors acquired after all subcarriers are subjected to weighting processing, is defined by the following equation (84):

$$[ {W}_{p}^{( - 21 ) H} {r}^{( - 21 )} ( m ) {W}_{p}^{( - 7 ) H} {r}^{( - 7 )} ( m ) {W}_{p}^{( 7 ) H} {r}^{( 7 )} ( m ) {W}_{p}^{( 21 ) H} {r}^{( 21 )} ( m ) ] ≃ {e}^{{jφ}_{m}} {Φ}^{- 1} [ {p}^{( - 21 )} ( m ) {p}^{( - 7 )} ( m ) {p}^{( 7 )} ( m ) {p}^{( 21 )} ( m ) ] \qquad ( 84 )$$

If the rank of the matrix using, as column vectors, the pilot signal vectors given by the equation (84) is equal to the number of streams, e^{jΨm} Φ⁻¹ can be estimated, using the following equations (85) and (86) that are acquired by multiplying both sides of the equation (84) by the generalized inverse matrix of the matrix from the right hand side:

$$\begin{matrix}{e}^{{jφ}_{m}} {Φ}^{- 1} = [ {W}_{p}^{( - 21 ) H} {r}^{( - 21 )} ( m ) {W}_{p}^{( - 7 ) H} {r}^{( - 7 )} ( m ) {W}_{p}^{( 7 ) H} {r}^{( 7 )} ( m ) {W}_{p}^{( 21 ) H} {r}^{( 21 )} ( m ) ] \\ [ {p}^{( - 21 )} ( m ) {p}^{( - 7 )} ( m ) {p}^{( 7 )} ( m ) {p}^{( 21 )} ( m ) ] \_ & ( 85 ) \\ where , & \\ {[ {p}^{( - 21 )} ( m ) {p}^{( - 7 )} ( m ) {p}^{( 7 )} ( m ) {p}^{( 21 )} ( m ) ]}^{-} = [ \begin{matrix}{p}^{( - 21 ) H} ( m ) \\ {p}^{( - 7 ) H} ( m ) \\ {p}^{( 7 ) H} ( m ) \\ {p}^{( 21 ) H} ( m )\end{matrix} ] {( [ {p}^{( - 21 )} ( m ) {p}^{( - 7 )} ( m ) {p}^{( 7 )} ( m ) {p}^{( 21 )} ( m ) ] [ \begin{matrix}{p}^{( - 21 ) H} ( m ) \\ {p}^{( - 7 ) H} ( m ) \\ {p}^{( 7 ) H} ( m ) \\ {p}^{( 21 ) H} ( m )\end{matrix} ] )}^{- 1} & ( 86 )\end{matrix}$$

If the generalized inverse matrix employed in the equation (84) is set as Π, and the i^{th} row vector of Π is set as <Πᵢ>, e^{jΨ1} Φ⁻¹ can be estimated by summing up the weighted signal components of the subcarriers of the 1^{st} symbol, as shown in the following equation (87):

$${e}^{{jψ}_{1}} = {W}_{p}^{( - 21 ) H} {r}^{( - 21 )} ( 1 ) {Π}_{1} + {W}_{p}^{( - 7 ) H} {r}^{( - 7 )} ( 1 ) {Π}_{2} + {W}_{p}^{( 7 ) H} {r}^{( 7 )} ( 1 ) {Π}_{3} + {W}_{p}^{( 21 ) H} {r}^{( 21 )} ( 1 ) {Π}_{4} \qquad ( 87 )$$

Since signals known to the wireless receiving apparatus are transmitted as pilot signals, Π can be beforehand computed. Accordingly, the computation of Π does not cause any processing delay. This means that each subcarrier can be weighted immediately after the channel response of each subcarrier is estimated, i.e., it is not necessary to wait for all subcarriers to be subjected to channel response estimation.

On the other hand, if the row vectors of the column vectors included in the equation (84) are orthogonal to each other, its inverse matrix can be expressed as a simple structure, and hence the equation (85) can be rewritten as the following equation (88):

$${e}^{{jψ}_{1}} {Φ}^{- 1} = \frac{1}{E} ( {W}_{p}^{( - 21 ) H} {r}^{( - 21 )} ( 1 ) {p}^{( - 21 ) H} ( 1 ) + {W}_{p}^{( - 7 ) H} {r}^{( - 7 )} ( 1 ) {p}^{( - 7 ) H} ( 1 ) + {W}_{p}^{( 7 ) ( H )} {r}^{( 7 )} ( 1 ) {p}^{( 7 ) H} ( 1 ) + {W}_{p}^{( 21 ) H} {r}^{( 21 )} ( 1 ) {p}^{( 21 ) H} ( 1 ) ) \qquad ( 88 )$$

Further, when known signals for channel response estimation are transmitted in the frame format of FIG. 10, the inverse matrix of estimated channel-response error components is expressed as shown in the equation (47), therefore estimation can be performed simply by multiplying weighted results concerning pilot subcarriers by scalars, and summing up the multiplication results, as shown in the following equation (89):

$$[ \begin{matrix}α \\ β\end{matrix} ] = \frac{1}{E} ( {p}_{1}^{( - 21 ) *} ( 1 ) {W}_{p}^{( - 21 ) H} {r}^{( - 21 )} ( 1 ) + {p}_{1}^{( - 7 ) *} ( 1 ) {W}_{p}^{( - 7 ) H} {r}^{( - 7 )} ( 1 ) + {p}_{1}^{( 7 ) *} ( 1 ) {W}_{p}^{( 7 ) H} {r}^{( 7 )} ( 1 ) + {p}_{1}^{( 21 ) *} ( 1 ) {W}_{p}^{( 21 ) H} {r}^{( 21 )} ( 1 ) ) \qquad ( 89 )$$

Further, when each pilot signal contains only data of +1 or −1, it is sufficient if the sum of the weights of pilot subcarriers or the difference therebetween is computed in accordance with the type of the transmitted pilot signal sequence. Therefore, estimation can be more simplified.

Consideration will be given to a format example in which a signal corresponding to a particular stream is transmitted in a symbol in which

$${X}^{( k )} = [ \begin{matrix}1 & 0 \\ 0 & 1\end{matrix} ] \qquad ( 90 )$$

In this case, the estimated channel-response error matrix Φ, and pilot matrix P^{(k)} corresponding to the pilot subcarrier with subcarrier number k can be given by the following equations (91) and (92), respectively:

$$\begin{matrix}Φ = [ \begin{matrix}{e}^{{jφ}_{1}} & 0 \\ 0 & {e}^{{jφ}_{2}}\end{matrix} ] = [ \begin{matrix}α & 0 \\ 0 & β\end{matrix} ] & ( 91 ) \\ {P}^{( k )} ( 1 ) = [ \begin{matrix}{p}_{1}^{( k )} ( 1 ) & 0 \\ 0 & {p}_{2}^{( k )} ( 1 )\end{matrix} ] & ( 92 )\end{matrix}$$

Either a preamble signal sequence given by the equation (90) or a signal sequence given by the following equation (93) is transmitted, in units of subcarriers, as a known signal for channel response estimation. When the signal sequence given by the following equation (93) is transmitted as the known signal for channel response estimation, a pilot matrix corresponding to each subcarrier can be given by the following equations (93) and (94), instead of by the equation (92):

$$\begin{matrix}{X}^{( {k}^{′} )} = [ \begin{matrix}0 & 1 \\ 1 & 0\end{matrix} ] & ( 93 ) \\ {P}^{( {k}^{′} )} ( 1 ) = [ \begin{matrix}0 & {p}_{1}^{( {k}^{′} )} ( 1 ) \\ {p}_{2}^{( {k}^{′} )} ( 1 ) & 0\end{matrix} ] & ( 94 )\end{matrix}$$

Also in the above case, estimation can be performed in a simple manner by appropriately setting the above-mentioned pilot matrix in accordance with each known symbol employed for channel response estimation, and summing up the weighted signal components of the pilot subcarriers as shown in the following equation (95):

$$[ \begin{matrix}α \\ β\end{matrix} ] = \frac{1}{E} ( {P}^{( - 21 ) H} ( 1 ) {W}_{p}^{( - 21 ) H} {r}^{( - 21 )} ( 1 ) + {P}^{( - 7 ) H} ( 1 ) {W}_{p}^{( - 7 ) H} {r}^{( - 7 )} ( 1 ) + {P}^{( 7 ) H} ( 1 ) {W}_{p}^{( 7 ) H} {r}^{( 7 )} ( 1 ) + {P}^{( 21 ) H} ( 1 ) {W}_{p}^{( 21 ) H} {r}^{( 21 )} ( 1 ) ) \qquad ( 95 )$$

When the pilot matrix is given by the equation (92) or (94), the product of the complex conjugate transposed matrices of P^{(k)}(1) and weight matrix Wp^{(k)} is acquired simply by multiplying each column vector of the weight matrix Wp^{(k)} by the absolute value of the complex conjugate value corresponding to diagonal or non-diagonal components of the pilot matrix. Since the pilot signal components are known to the wireless receiving apparatus, they can be beforehand reflected in the weight matrix as shown in the following equations (96) to (99):

W′ₚ⁽⁻²¹⁾=Wₚ⁽⁻²¹⁾P⁽⁻²¹⁾(1) (96)

W′ₚ⁽⁻⁷⁾=Wₚ⁽⁻⁷⁾P⁽⁻⁷⁾(1) (97)

W′ₚ⁽⁷⁾=Wₚ⁽⁷⁾P⁽⁷⁾(1) (98)

W′ₚ⁽²¹⁾=Wₚ⁽²¹⁾P⁽²¹⁾(1) (99)

Therefore, the estimated channel-response error components can be extracted simply by multiplying the signal components of the pilot subcarriers in the 1^{st} symbol by the weights given by the equations (96) to (99), and summing up the multiplication results.

As described above, estimated channel-response error components can be extracted simply by multiplying, by weights, the received signal components of pilot subcarriers in accordance with a sequence of known signal components for channel response estimation, and each weight for the corresponding pilot subcarrier can be determined without being influenced by the channel response values of the other pilot subcarriers, although different weight computation methods are used between different types of sequences of known signal components. As a result, processing delay that occurs during the computation of weights can be reduced.

In the above description, MMSE-scheme weights are assumed as the weights for extracting pilot signals. Consideration will now be given to the case of using weights of the ZF scheme that is a general weight computation scheme like the MMSE scheme. Weights of the ZF scheme are given by the following equation (100):

Wₚ^{(k)}=Ĥ^{(k)}(\hat{H}^{(k)H}Ĥ^{(k))}⁻¹ (100)

When channel response estimation is expressed as the product of H^{(k)} and Φ as shown in the equation (24), the equation (100) can be rewritten as the following equation (101):

$$\begin{matrix}{W}_{p}^{( k )} = {H}^{( k )} {Φ ( {Φ}^{H} {H}^{( k ) H} {H}^{( k )} Φ )}^{- 1} \\ = {{H}^{( k )} ( {H}^{( k ) H} {H}^{( k )} )}^{- 1} {( {Φ}^{H} )}^{- 1}\end{matrix} \qquad ( 101 )$$

Further, the following equation (102), similar to the equation (70), can be acquired by multiplying the signal component of each pilot subcarrier by the corresponding weight:

Wₚ^{(k)H}r^{(k)}(m)≃e^{jψm}Φ⁻¹p^{(k)}(m) (102)

It is understood from the above that the product of the inverse matrix of estimated channel-response error components and transmission signals is extracted in both the MMSE and ZF schemes, although the influence of noise components differs between them. This means that the same method as employed for the MMSE scheme can also be employed for the ZF scheme.

Further, descriptions have been given of the case of transmitting known signals for channel response estimation, which are included in the frame format of FIG. 10 or given by the equations (90) and (93). However, the known signals for channel response estimation in the third embodiment are not limited to them.

No detailed description is given of the method of correcting estimated channel-response values by the estimated-channel-response-error correction unit 1143 using Φ⁻¹ estimated as the above, and the operations of the MIMO demodulation preprocessing unit 1144, phase correction unit 1145 and MIMO demodulator 1146, since they are identical to those of the first embodiment.

As described above, the third embodiment can correct an estimated channel-response error due to frequency offset and phase noise, and hence realize highly accurate MIMO demodulation. Further, each weight for extracting an estimated channel-response error is computed only from the channel response of the corresponding subcarrier, the corresponding pilot signal sequence and the corresponding noise power. Accordingly, the channel response values of the other pilot subcarriers are not necessary. As a result, processing delay that occurs during the computation of weights is reduced.

### Fourth Embodiment

A wireless receiving apparatus according to a fourth embodiment has the same configuration as that of the first to third embodiments shown in FIGS. 11 or 13, and is similar to the first to third embodiments in that an estimated channel-response error, caused by the frequency offset between the transmission apparatus and wireless receiving apparatus and phase noise resulting therefrom, are corrected using pilot subcarriers.

The fourth embodiment differs from the first to third embodiments in the scheme of computing a weight in units of pilot subcarriers to acquire an estimated channel-response error. Specifically, the fourth embodiment employs, for the estimated-channel-response-error computation unit 1142, a weight computation method differing from the corresponding methods in the first to third embodiments.

In the third embodiment, to reduce processing delay that occurs during the computation of each weight for the corresponding pilot subcarrier, each weight is computed without using the channel response values of the other subcarriers. Although this method can reduce processing delay, transmission characteristic may be degraded when subcarriers have different characteristic levels under the environment of frequency selective fading. This is because the channel response characteristic of each subcarrier is not reflected when estimated channel-response error components are extracted using the outputs acquired after weighting processing, and same-ratio computation is performed on both subcarriers of high characteristic levels and subcarriers of low characteristic levels.

In light of the above, the fourth embodiment employs a scheme in which each weight used for computing an estimated channel-response error is computed without the channel response values of the subcarriers other than the subcarrier corresponding to each weight, and the channel response characteristic of each subcarrier is reflected during the computation of the estimated channel-response error.

The operation of the estimated-channel-response-error computation unit 1142 in the fourth embodiment will be described.

The product of the inverse matrix Φ⁻¹ of an estimated channel-response error matrix and transmitted pilot vector can be extracted as shown in the equation (70) by multiplying each subcarrier by the corresponding weight given by the equation (60) (in the second embodiment) or the equation (100) (in the third embodiment). Namely, the inverse matrix Φ⁻¹ can be estimated from each pilot signal output.

Assume here that the pilot signal components corresponding to the column vectors of the pilot matrix given by the equation (37), which are transmitted by the corresponding pilot subcarrier, are orthogonal to each other. These pilot signal components will hereinafter be referred to as “orthogonal pilots.”

When such orthogonal pilots are transmitted, the estimated channel-response error components can be computed by computing the sum of or the difference between the levels of the outputs of the pilot subcarriers acquired after weighting processing, as in the third embodiment. Further, since the required number of necessary pilot subcarriers is 1 or 2 when the number of streams is 2, if the required number of necessary pilot subcarriers is more than 2, the pilot signal vector is linearly dependent.

Consideration will be given of an example case where the number of streams is 2, the number of pilot subcarriers is 4 as in the case of FIG. 9, and the pilot signal vector of each pilot subcarrier is given by the following equation (103):

$${p}^{( - 21 )} ( 1 ) = {[ \begin{matrix}1 & 1\end{matrix} ]}^{T} , \\ {p}^{( - 7 )} ( 1 ) = {[ \begin{matrix}1 & - 1\end{matrix} ]}^{T} , \\ {p}^{( 7 )} ( 1 ) = {[ \begin{matrix}- 1 & - 1\end{matrix} ]}^{T} , \\ {p}^{( 21 )} ( 1 ) = {[ \begin{matrix}- 1 & 1\end{matrix} ]}^{T} \qquad ( 103 )$$

In this case, the relationship given by the following equations (104) and (105) is established, therefore the pilot signal vectors with subcarrier numbers −21 and 7 are linearly dependent, and similarly the pilot signal vectors with subcarrier numbers −7 and 21 are linearly dependent:

p⁽⁻²¹⁾(1)=−p⁽⁷⁾(1) (104)

p⁽⁻⁷⁾(1)=−p⁽²¹⁾(1) (105)

Thus, in the fourth embodiment, when orthogonal pilots are used and combinations of linearly dependent pilot signal vectors exist, they are subjected to maximum ratio combine, and then the sum or difference is computed to acquire estimated channel-response error components, as in the third embodiment. As a result, where subcarriers have different channel response values in a frequency selective fading environment, a frequency diversity effect can be acquired to thereby suppress degradation of communication performance due to characteristic differences between the subcarriers.

A description will be given of the method of subjecting combinations of linearly dependent vectors to maximum ratio combine.

Assume here that an MMSE-scheme weight as given by the equation (68) is used as a weight for extracting each subcarrier pilot signal. In this case, the maximum-ratio-combine coefficient, used when the j^{th} stream is extracted, is acquired by normalizing the corresponding weight output using the least mean value of errors, and hence is given by the following equation (106):

cⱼ^{(k)}=1.0−wⱼ^{(k)H}ĥⱼ^{(k)} (106)

where <wⱼ^{(k)}> is the j^{th} column vector of the weight matrix, and <hⱼ^{(k)}> is the j^{th} column vector of the channel response matrix estimated using the equation (24).

On the other hand, if a ZF-scheme weight as given by the equation (100) is used as a weight for extracting each subcarrier pilot signal, the coefficient given by the following equation (107) can be used for the above normalization:

$${c}_{j}^{( k )} = \frac{1}{{‖ {w}_{j}^{( k )} ‖}^{2}} \qquad ( 107 )$$

If the above-mentioned coefficient is used for the maximum ration combine, variation may occur in the level of each output pilot signal component because of variation in channel response, therefore normalization is performed in each subcarrier subjected to summation. When the pilot signal component as given by the equation (103) is used, normalization is performed as shown in the following equations (108) to (111):

$$\begin{matrix}{c}_{1}^{′ ( - 21 )} = \frac{{c}_{1}^{( - 21 )}}{{c}_{1}^{( - 21 )} + {c}_{1}^{( 7 )}} , {c}_{2}^{′ ( - 21 )} = \frac{{c}_{2}^{( - 21 )}}{{c}_{2}^{( - 21 )} + {c}_{2}^{( 7 )}} & ( 108 ) \\ {c}_{1}^{′ ( 7 )} = \frac{{c}_{1}^{( 7 )}}{{c}_{1}^{( - 21 )} + {c}_{1}^{( 7 )}} , {c}_{2}^{′ ( 7 )} = \frac{{c}_{2}^{( 7 )}}{{c}_{2}^{( - 21 )} + {c}_{2}^{( 7 )}} & ( 109 ) \\ {c}_{1}^{′ ( - 7 )} = \frac{{c}_{1}^{( - 7 )}}{{c}_{1}^{( - 7 )} + {c}_{1}^{( 21 )}} , {c}_{2}^{′ ( - 7 )} = \frac{{c}_{2}^{( - 7 )}}{{c}_{1}^{( - 7 )} + {c}_{2}^{( 21 )}} & ( 110 ) \\ {c}_{1}^{′ ( 21 )} = \frac{{c}_{1}^{( 21 )}}{{c}_{1}^{( - 7 )} + {c}_{1}^{( 21 )}} , {c}_{2}^{′ ( 21 )} = \frac{{c}_{2}^{( 21 )}}{{c}_{2}^{( - 7 )} + {c}_{2}^{( 21 )}} & ( 111 )\end{matrix}$$

If the pilot signal components extracted using the normalized coefficients are combined, the following equations (112) and (113) are acquired:

$$\begin{matrix}{e}^{j {ψ}_{1}} {Φ}^{- 1} [ \begin{matrix}1 \\ 1\end{matrix} ] = [ \begin{matrix}{c}_{1}^{′ ( - 21 )} & 0 \\ 0 & {c}_{2}^{′ ( - 21 )}\end{matrix} ] {W}_{p}^{( - 21 ) H} {r}^{( - 21 )} ( 1 ) + [ \begin{matrix}{c}_{1}^{′ ( 7 )} & 0 \\ 0 & {c}_{2}^{′ ( 7 )}\end{matrix} ] {W}_{p}^{( 7 ) H} {r}^{( 7 )} ( 1 ) & ( 112 ) \\ {e}^{j {ψ}_{1}} {Φ}^{- 1} [ \begin{matrix}1 \\ - 1\end{matrix} ] = [ \begin{matrix}{c}_{1}^{′ ( - 7 )} & 0 \\ 0 & {c}_{2}^{′ ( - 7 )}\end{matrix} ] {W}_{p}^{( - 7 ) H} {r}^{( - 7 )} ( 1 ) + [ \begin{matrix}{c}_{1}^{′ ( 21 )} & 0 \\ 0 & {c}_{2}^{′ ( 21 )}\end{matrix} ] {W}_{p}^{( 21 ) H} {r}^{( 21 )} ( 1 ) & ( 113 )\end{matrix}$$

Each weight may be beforehand multiplied by the corresponding maximum-ratio-combine coefficient given by the equations (108) to (111), and is used to weight the corresponding signal component. Alternatively, each signal component acquired after weighting processing may be multiplied by the corresponding maximum ratio combine coefficient. Any target may be multiplied by a maximum ratio combine coefficient using any method or procedure, if an output as given by the equation (112) or (113) can be acquired.

Further, the first and second columns of Φ⁻¹ can be acquired from the sum of values given by the equations (112) and (113) and the difference therebetween, respectively, as shown in the following equations (114) and (115):

$$\begin{matrix}[ \begin{matrix}α \\ γ\end{matrix} ] = \frac{{e}^{j {ψ}_{1}}}{2} {Φ}^{- 1} [ \begin{matrix}1 \\ 1\end{matrix} ] + \frac{{e}^{j {ψ}_{1}}}{2} {Φ}^{- 1} [ \begin{matrix}1 \\ - 1\end{matrix} ] & ( 114 ) \\ [ \begin{matrix}β \\ δ\end{matrix} ] = \frac{{e}^{j {ψ}_{1}}}{2} {Φ}^{- 1} [ \begin{matrix}1 \\ 1\end{matrix} ] - \frac{{e}^{j {ψ}_{1}}}{2} {Φ}^{- 1} [ \begin{matrix}1 \\ - 1\end{matrix} ] & ( 115 )\end{matrix}$$

When an orthogonal sequence is used as a sequence of known signal components for channel response estimation, it is sufficient if only the sum of values given by the equations (112) and (113) is computed as shown in the equation (114). This is because the second column of Φ⁻¹ can be acquired based on the estimated first column of Φ⁻¹, as shown in the equation (47).

Pilot signal vectors as given by the equation (103) have been described. However, the pilot signal vectors are not limited to those of the equation (103). It is sufficient if they use orthogonal pilots. Further, each pilot subcarrier may transmit a pilot signal included in a particular stream. The number of pilot subcarriers is not limited to four. Any number of pilots may be employed if combinations of linearly dependent vectors exist.

No detailed description is given of the method of correcting estimated channel-response values by the estimated-channel-response-error correction unit 1143 using Φ⁻¹ estimated as the above, and the operations of the MIMO demodulation preprocessing unit 1144, phase correction unit 1145 and MIMO demodulator 1146, since they are identical to those of the first embodiment.

As described above, in the fourth embodiment, an estimated channel-response error due to frequency offset and phase noise can be corrected, thereby realizing highly accurate MIMO demodulation. In this case, it is not necessary to compute each weight for extracting estimated cannel-response errors, in light of the channel response values of all subcarriers used for estimation, therefore processing delay that occurs during the computation of weights can be reduced. Further, since a plurality of pilot subcarrier signal components are combined by maximum ratio combine, degradation due to characteristic differences caused by the different channel response values of the subcarriers can be suppressed.

### Fifth Embodiment

A wireless receiving apparatus according to a fifth embodiment has the same configuration as that of the first to fourth embodiments shown in FIGS. 11 or 13, and is similar to the first to fourth embodiments in that an estimated channel-response error, caused by the frequency offset between the transmission apparatus and wireless receiving apparatus and phase noise resulting therefrom, is corrected using pilot subcarriers.

The fifth embodiment differs from the first to fourth embodiments in the scheme of computing an estimated channel-response error, i.e., in the weight computation method employed in the estimated-channel-response-error computation unit 1142. In the first to fourth embodiments, a weight for extracting estimated channel-response components is computed in units of pilot subcarriers, using the corresponding estimated channel response, and is multiplied by the corresponding pilot subcarrier, thereby acquiring the estimated channel-response components. The methods employed in the first to fourth embodiments ignore the influence of thermal noise contained in channel-response estimation results, and compute only the estimated channel-response error caused by frequency offset and phase noise.

However, in general, since only a limited number of symbols of known signals for channel response estimation are transmitted, channel-response estimated results are inevitably influenced by unnecessary signals such as thermal noise. This influence becomes conspicuous if the header signal is shortened to enhance the transmission efficiency, with the result that the computation accuracy at which estimated channel-response components due to frequency offset and phase noise are computed may well be degraded.

In view of the above, the fifth embodiment computes estimated channel-response components due to frequency offset and phase noise, using the Total Least Square (TLS) method that considers errors contained in estimated channel response values because of unnecessary signals.

The operation of the estimated-channel-response-error computation unit 1142 of the fifth embodiment will be described.

Assume here that the relationship given by the equation (39) is established between estimated channel-response error components, and the pilot matrix of each pilot subcarrier determined by known symbols for channel response estimation and the pilot signal components of the 1^{st} data symbol.

In this case, the equation (39) is rewritten as the following equations (116), (117) and (118):

$$\begin{matrix}r ( 1 ) = A φ + n ( 1 ) \\ where , & ( 116 ) \\ A = [ \begin{matrix}{\hat{H}}^{( - 21 )} {P}^{( - 21 )} ( 1 ) \\ {\hat{H}}^{( - 7 )} {P}^{( - 7 )} ( 1 ) \\ {\hat{H}}^{( 7 )} {P}^{( 7 )} ( 1 ) \\ {\hat{H}}^{( 21 )} {P}^{( 21 )} ( 1 )\end{matrix} ] & ( 117 ) \\ n ( 1 ) = [ \begin{matrix}{n}^{( - 21 )} ( 1 ) \\ {n}^{( - 7 )} ( 1 ) \\ {n}^{( 7 )} ( 1 ) \\ {n}^{( 21 )} ( 1 )\end{matrix} ] & ( 118 )\end{matrix}$$

where A is a matrix including the products of estimated channel-response matrices and pilot matrices, and <n(1)> is the thermal noise vector of each subcarrier.

In TLS estimation, ξ and <e>, which minimize the solution of the following expression (119), are acquired, and an estimated channel-response error <φ> is computed using the following equation (120):

∥r(1)·ξ−Ae∥² (119)

$$φ = \frac{1}{ξ} \cdot e \qquad ( 120 )$$

where ∥ ∥ indicates a vector norm. Since the minimal solution of the expression (119) contains trivial values, i.e., <e>=<0> and ξ=0, the equation can be further developed as the following equation (121), using the Lagrange undetermined multiplier method:

$${‖ r ( 1 ) \cdot ξ - Ae ‖}^{2} - λ ( {‖ e ‖}^{2} + {\vert ξ \vert}^{2} - 1 ) = {‖ [ A r ( 1 ) ] [ \begin{matrix}e \\ - ξ\end{matrix} ] ‖}^{2} - λ ( {‖ e ‖}^{2} + {\vert ξ \vert}^{2} - 1 ) \qquad ( 121 )$$

From the above, ξ and <e> that satisfy the following equation (122) are to-be-acquired values:

$${[ A r ( 1 ) ]}^{H} [ A r ( 1 ) ] [ \begin{matrix}e \\ - ξ\end{matrix} ] = λ [ \begin{matrix}e \\ - ξ\end{matrix} ] \qquad ( 122 )$$

It is understood that [<e>−ξ]^{T}, which minimizes the equation (121), is an eigenvector corresponding to the minimum eigenvalue of [A<r(1)>]^{H}[A <r(1)>]. Accordingly, matrix [A<r(1)>]^{H}[A<r(1)>] is computed, using received-signal vectors <r(1)> that include the received-signal vectors of pilot subcarriers, and A that includes the estimated channel-response matrices of the pilot subcarriers and pilot matrices. After that, the eigenvector corresponding to the minimum eigenvalue of the matrix [A<r(1)>]^{H}[A<r(1)>] is computed and used to solve the equation (120), thereby computing estimated channel-response error components. Further, using the estimated <φ> and the equations (32) and (33), Φ⁻¹ can be estimated.

Furthermore, when an orthogonal sequence is used as a sequence of known signal components for channel response estimation, <φ> and P^{(k)}(1) can be rewritten as shown in the equations (48) and (51), and hence Φ⁻¹ can be estimated using the equation (47) or (91) in accordance with the type of a sequence of known symbols for channel response estimation.

No detailed description is given of the method of correcting estimated channel-response values by the estimated-channel-response-error correction unit 1143 using Φ⁻¹ estimated as the above, and the operations of the MIMO demodulation preprocessing unit 1144, phase correction unit 1145 and MIMO demodulator 1146, since they are identical to those of the first embodiment.

As described above, the fifth embodiment can correct the estimated channel-response error due to frequency offset and phase noise, and hence realize highly accurate MIMO demodulation. Since in this case, the estimated channel-response error is computed in consideration of the fact that they are influenced by noise, they can be corrected with high accuracy even in the environment influenced by thermal noise.

### Sixth Embodiment

Referring to FIG. 14, the configuration of a wireless receiving apparatus according to a sixth embodiment will be described. FIG. 14 shows a configuration example of the apparatus of the sixth embodiment, in which the number of to-be-multiplexed streams is 2, and the number of receiving antennas is also 2.

In the first to fifth embodiments, an estimated channel-response error due to frequency offset and phase noise is computed and corrected. In this method, however, it is necessary to perform MIMO demodulation preprocessing after channel-response error estimation and before demodulation of data subcarriers, therefore the MIMO demodulation preprocessing unit must be operated at high speed. Further, it is necessary to prepare a large-capacity buffer for allowing processing delay, and accumulate signals therein, which inevitably increases the required area of the chip and/or the sizes of the modules.

To solve the above problems, in MIMO demodulation preprocessing performed in the sixth embodiment, each estimated channel-response error is computed from the corresponding estimated channel response acquired before correction, and the MIMO demodulation preprocessing result is corrected, instead of the channel response, after the estimated channel-response error components are computed.

The wireless receiving apparatus of the sixth embodiment comprises receiving antennas 1101 and 1102, radio units 1111 and 1112, GI removal units 1121 and 1122, Fourier transformers 1131 and 1132, channel-response estimation unit 1141, estimated-channel-response-error computation unit 1142, phase correction unit 1145, MIMO demodulator 1146, MIMO demodulation preprocessing unit 1401 and estimated-channel-response-error correction unit 1402. Although, in FIG. 14, the channel-response estimation unit 1141 has a structure for performing estimation using the outputs of the Fourier transformers, it may have a structure, as shown in FIG. 13, for performing estimation using time-domain signals acquired before Fourier transform. It is sufficient if the channel response of each subcarrier can be estimated.

The MIMO demodulation preprocessing unit 1401 performs preprocessing for MIMO demodulation, i.e., performs MIMO demodulation preprocessing on the signals before correction. In the first to fifth embodiments, MIMO demodulation preprocessing is performed on the channel-response estimation results acquired after the estimated channel-response error is corrected, as is shown in the equation (52). In contrast, in the sixth embodiment, MIMO demodulation preprocessing is performed on the signals acquired before correction.

The MIMO demodulation preprocessing unit 1401 performs, on an estimated channel response, processing according to the demodulation scheme employed in the MIMO demodulator 1146, as in the first embodiment. Also in the sixth embodiment, the MIMO demodulator 1146 may employ any demodulation scheme as in the first embodiment, and the MIMO demodulation preprocessing unit 1401 performs the same processing as in the first embodiment.

The estimated-channel-response-error correction unit 1402 corrects the estimated channel-response error corresponding to the subcarriers and the coefficients computed by the MIMO demodulation preprocessing unit 1401.

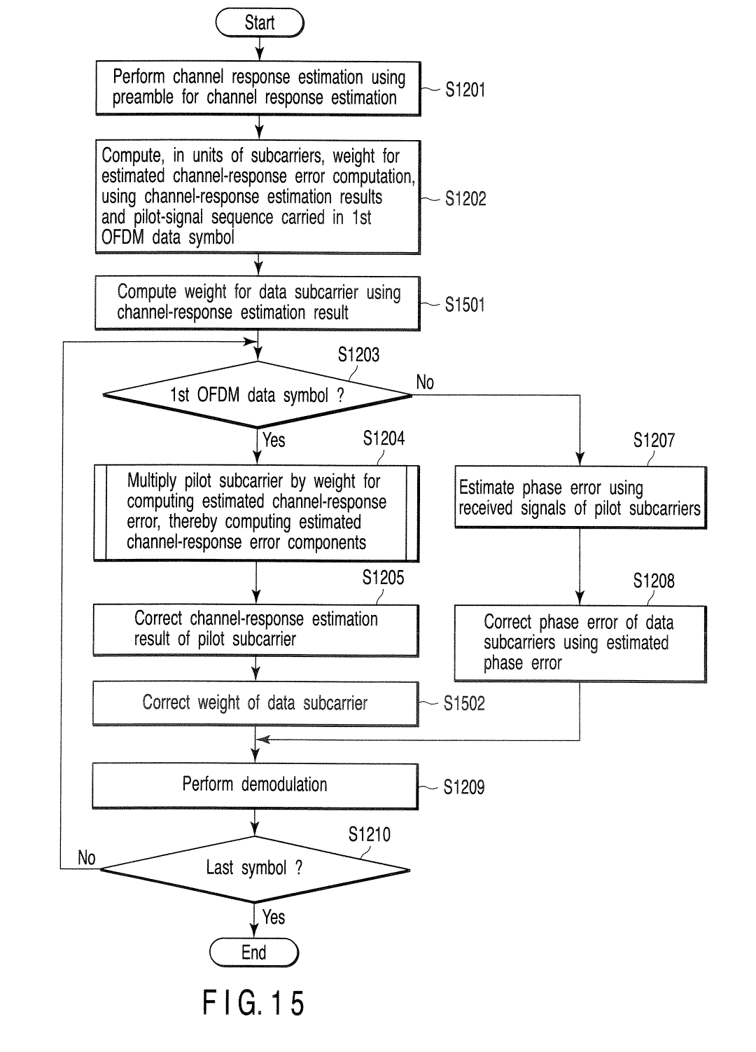

Referring to FIGS. 14 and 15, the operation of the receiving apparatus of the sixth embodiment will be described in detail. FIG. 14 is a block diagram illustrating a configuration example of the apparatus, and FIG. 15 is a flowchart useful in explaining the operation. Since the transmission apparatus for transmitting signals received by the receiving apparatus of the sixth embodiment is similar to that employed in the first embodiment, no detailed description is given thereof. Further, elements similar to the above-described ones are denoted by corresponding reference numbers, and no description is given thereof.

Referring to FIG. 15, an operation example of the wireless receiving apparatus of FIG. 14 will be described. The steps similar to the above-described ones are denoted by corresponding reference numbers, and no description is given thereof. Steps S1201 to S1205 and S1207 to S1210 are similar to those shown in FIG. 12. In FIG. 15, steps S1501 and S1502 are added.

At step S1501, the MIMO demodulation preprocessing unit 1401 computes weights for data subcarriers, using the channel-response estimation results acquired at step S1201.

At step S1502, the estimated-channel-response-error correction unit 1402 corrects the estimated channel-response estimation results of pilot subcarriers, using the channel-response estimation results acquired at step S1201 and the estimated channel-response error components computed at step S1204, and also corrects the weights for data subcarriers computed at step S1510, using the corrected channel-response estimation results.

A description will now be given of the case of using a spatial filtering method as the MIMO demodulation scheme. In the spatial filtering method, each MMSE- or ZF-scheme weight computed for the corresponding subcarriers is multiplied by the received-signal vector of the corresponding subcarriers, the multiplexed streams are separated, and demodulation is performed in units of streams.

When known signals for channel response estimation are orthogonal ones, and X^{(k)} given by the equation (10) is a unitary matrix, the estimated channel-response matrix Φ given by the equation (25) is also a unitary matrix as shown in the equation (28) or (30).

Specifically, MMSE-scheme weights are given by the equation (69), while ZF-scheme weights are given by the equation (101). Although the weights given by the equations (69) and (101) are used for extracting the pilot signal components of pilot subcarriers, weights for extracting the signal components of data subcarriers can be acquired by completely the same computations. Since in the equation (101), Φ is a unitary matrix, the equation (101) can be rewritten as the following equation (123):

$$\begin{matrix}{W}_{p}^{( k )} = {{H}^{( k )} ( {H}^{( k ) H} {H}^{( k )} )}^{- 1} {( {Φ}^{H} )}^{- 1} \\ = {{H}^{( k )} ( {H}^{( k ) H} {H}^{( k )} )}^{- 1} Φ\end{matrix} \qquad ( 123 )$$

It can be understood from the equations (69) and (123) that each weight can be acquired by multiplying, by the estimated channel-response matrix Φ from the right hand side, the weight acquired when the channel response corresponding to each weight contains no estimated error, regardless of whether MMSE- or ZF-scheme weights are utilized.

On the other hand, as in the first to fifth embodiments, when the estimated channel-response error components are computed, it can be understood in either case that the value acquired by multiplying the inverse matrix of Φ by the phase error of a symbol used for estimation is estimated. This means that it is not always necessary to correct the estimation result of the channel response, and then compute the corresponding weight using the corrected channel response. Instead, the weight can be corrected as shown in the following equation (124):

W′_{d}^{(k)}=W_{d}^{(k)}e^{jΨ}^{₁}Φ⁻¹ (124)

where W_{d}^{(k)} is each weight for extracting the data signal of the corresponding data subcarrier. The estimated-channel-response-error correction unit 1402 performs the above-described weight correction on all data subcarriers.

Concerning pilot subcarriers, when the phase correction unit 1145 corrects, as described in the first embodiment, each replica signal as given by the equation (54) and generated from the corresponding estimated channel response, the estimated-channel-response-error correction unit 1402 corrects the estimated channel response, and supplies the corrected channel response to the phase correction unit 1145, as in the first to fifth embodiments.

Since the procedure, employed in the sixth embodiment, of causing the phase correction unit 1145 to correct the phase error of each OFDM symbol using the corresponding corrected channel response, and causing the MIMO demodulator 1146 to perform demodulation using the corresponding corrected weights, is similar to that employed in the first to fifth embodiments, no detailed description is given thereof.

As described above in detail, the sixth embodiment can correct an estimated channel-response error caused by frequency offset and phase noise, thereby realizing highly accurate MIMO demodulation. Further, in the sixth embodiment, instead of correcting an estimated channel response, the values output from the MIMO demodulation preprocessing unit 1401 are corrected. Therefore, an operation for dealing with processing delay, a large-capacity buffer or high-speed MIMO demodulation preprocessing is not required, which enables the circuit structure to be simplified.

### Seventh Embodiment

A wireless receiving apparatus according to a seventh embodiment has the same configuration as that of the sixth embodiment shown in FIG. 14, and is similar to the sixth embodiment in that an estimated channel-response error, caused by the frequency offset between the transmission apparatus and wireless receiving apparatus and phase noise resulting therefrom, is computed using pilot subcarriers, and also in that the values acquired by the MIMO demodulation preprocessing unit are corrected. The seventh embodiment differs from the sixth embodiment in that in the former, a matrix of known signal components for channel response estimation is not a unitary matrix.

The estimated channel-response error depends upon known symbols for channel response estimation as shown in the equation (25). If the known symbol matrix X^{(k)} given by the equation (10) for channel response estimation is a unitary matrix, the weights computed by the MIMO demodulation preprocessing unit 1401 can be easily corrected as described in the sixth embodiment.

However, if X^{(k)} is not a unitary matrix, the weight matrix for MIMO demodulation cannot be expressed as a simple form as given by the equation (69) or (123), in which the weight matrix is expressed as the product of each estimated channel-response error component and the corresponding weight acquired when the corresponding channel response contains no estimated error.

Assume here that a signal matrix as given by the following equation (125) is used as such a known symbol matrix for channel response estimation as the above:

$${X}^{( k )} = [ \begin{matrix}1 & 1 & - 1 & - 1 \\ 1 & 1 & 1 & 1\end{matrix} ] \qquad ( 125 )$$

When a matrix of an orthogonal sequence, which is not a unitary matrix, is used, Φ in the equation (25) is not a unitary matrix. Therefore, MMSE-scheme weights and ZF-scheme weights are expressed as the equations (68) and (101), respectively. Even if the inverse matrix of Φ is estimated by one of the methods employed in the first to fifth embodiments, correction cannot be realized in this state.

This being so, the inverse matrix of Φ is estimated by one of the methods employed in the first to fifth embodiments, and then the estimated inverse matrix is modified to correct the weights estimated by the MIMO demodulation processing unit 1401.

Consideration is given to the case of using ZF-scheme weights for MIMO modulation. In this case, the weights are given by the equation (101), and it is evident that weight errors can be expressed by complex conjugate transposition of the inverse matrix of Φ. Accordingly, a matrix for correction can be acquired by computing the inverse matrix of the first-mentioned inverse matrix of Φ.

If the inverse matrix of Φ is estimated using the pilot subcarriers of the 1^{st} OFDM symbol, it contains the phase error of the 1^{st} OFDM symbol, and hence the corrected weights are given by the following equation (126):

$$\begin{matrix}{W}_{d}^{′ ( k )} = {W}_{d}^{( k )} ( {e}^{j {ψ}_{1}} {Φ}^{H} ) \\ = {{H}^{( k )} ( {H}^{( k ) H} {H}^{( k )} )}^{- 1} {( {Φ}^{H} )}^{- 1} ( {e}^{j {ψ}_{1}} {Φ}^{H} ) \\ = {{H}^{( k )} ( {H}^{( k ) H} {H}^{( k )} )}^{- 1} {e}^{j {ψ}_{1}}\end{matrix} \qquad ( 126 )$$

By performing MIMO demodulation using the weights acquired as the above, the seventh embodiment can provide the same advantage as the sixth embodiment in which a unitary matrix is used as a known symbol matrix for channel response estimation.

Consideration will then be given to the case of using MMSE-scheme weights for MIMO demodulation. In this case, if weights are computed using channel-response estimation results and Wiener solutions, they may be influenced by the estimated channel-response error as shown in the equation (68), which makes it difficult to perform correction. To avoid this, the self-correlation matrix and cross-correlation matrix of received signals are computed using the equations (63) and (64), thereby acquiring the weights. Since the number of the known symbols included in the equation (125) is 4, the number of the symbols subjected to averaging is 4.

In the equation (63), since each received-signal vector is multiplied by the complex conjugate transpose of the vector, the phase errors are canceled, and therefore the cross-correlation matrix can be estimated without the influence of frequency offset and phase noise. On the other hand, the computation of the cross-correlation matrix given by the equation (64) is equivalent to the channel response estimation computations given by the equation (18b) and (19a). The thus-obtained MMSE-scheme weights are similar to those given by the equation (69). In this case, the inverse matrix of Φ, estimated by one of the methods employed in the first to fifth embodiments, can be corrected directly.

Concerning pilot subcarriers, when the phase correction unit 1145 corrects each replica signal as given by the equation (54) and generated from the corresponding estimated channel response, the estimated channel response is corrected.

Since the procedure, employed in the seventh embodiment, of causing the phase correction unit 1145 to correct the phase error of each OFDM symbol using the corresponding corrected channel responses, and causing the MIMO demodulator 1146 to perform demodulation using the corresponding corrected weights, is similar to that employed in the first to sixth embodiments, no detailed description is given thereof.

As described above, in the seventh embodiment, an estimated error occurring during channel response estimation because of frequency offset and phase noise can be corrected, thereby realizing highly accurate MIMO demodulation. Further, not by correcting estimated channel response values, but by correcting values acquired from the MIMO demodulation preprocessing unit, processing delay does not occur, and a large-capacity buffer or high-speed MIMO demodulation preprocessing unit is not required, resulting in a simple circuit structure. In this case, weights can be directly corrected even if the matrix of known signal components for channel response estimation is not a unitary matrix.

### Eighth Embodiment

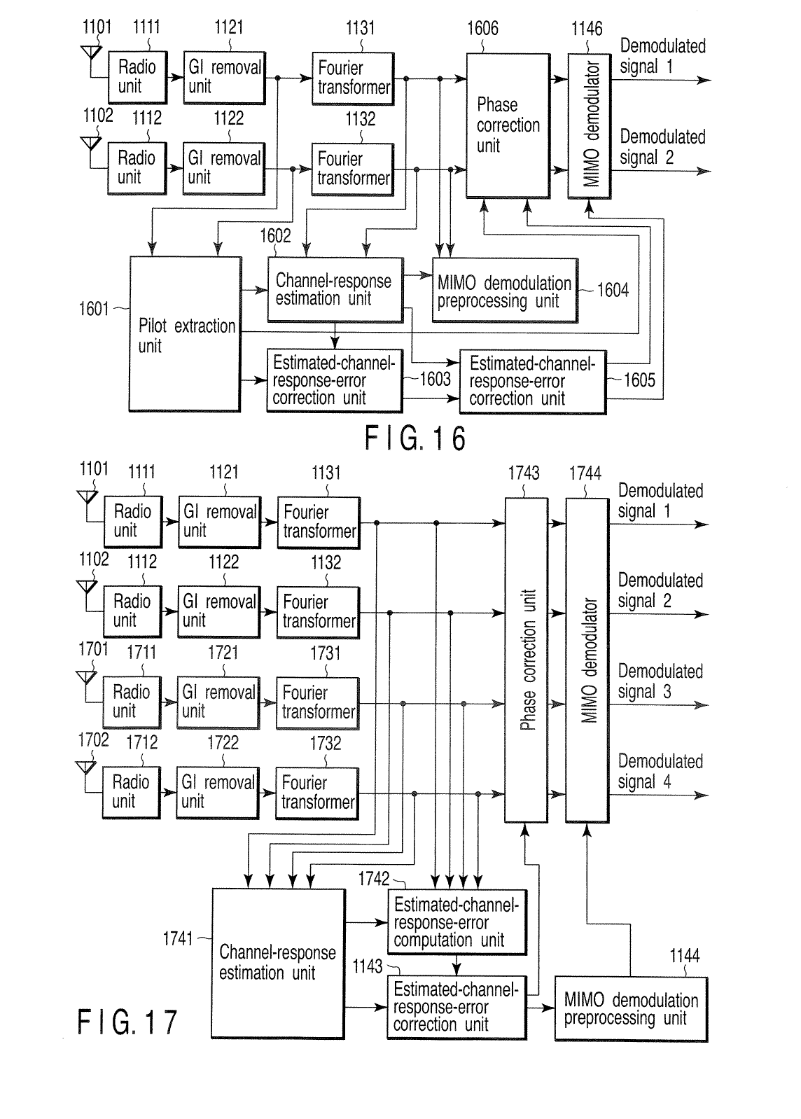

Referring to FIG. 16, the configuration of a wireless receiving apparatus according to an eighth embodiment will be described. FIG. 16 shows a configuration example of the wireless receiving apparatus of the eighth embodiment, in which the number of to-be-multiplexed streams is 2, and the number of receiving antennas is 2.

The wireless receiving apparatus of the seventh embodiment comprises receiving antennas 1101 and 1102, radio units 1111 and 1112, GI removal units 1121 and 1122, Fourier transformers 1131 and 1132, MIMO demodulator 1146, pilot extraction unit 1601, channel-response estimation unit 1602, estimated-channel-response-error computation unit 1603, MIMO demodulation preprocessing unit 1604, estimated-channel-response-error correction unit 1605 and phase correction unit 1605.

The pilot extraction unit 1601 transforms, into frequency domain signals, only pilot subcarrier signals included in the signals output from the GI removal units 1121 and 1122.

The channel-response estimation unit 1602 estimates the channel response values of subcarriers, using the pilot subcarriers output from the pilot extraction unit 1601 and the signals output from the Fourier transformers 1131 and 1132.

The estimated-channel-response-error computation unit 1603 estimates errors of the channel response values estimated by the channel-response estimation unit 1602, using the pilot subcarriers output from the pilot extraction unit 1601.

The MIMO demodulation preprocessing unit 1604 performs preprocessing for MIMO demodulation. The estimated-channel-response-error correction unit 1605 corrects the estimated channel response error corresponding to all subcarriers, and the coefficients computed by the MIMO demodulation preprocessing unit 1604. The phase correction unit 1606 corrects phase errors that occur in received signals.

In the first to seventh embodiments, outputs of the Fourier transformers 1131 and 1132 are utilized to correct an estimated channel-response error that occurs because of frequency offset and phase noise, or the signal processed by the MIMO demodulation preprocessing unit. In this method, however, the time ranging from the output of pilot subcarriers from the Fourier transformers 1131 and 1132 to the output of data subcarriers therefrom is short, and hence it may be difficult to compute and correct the estimated channel-response error by the time of data demodulation. If data demodulation is not performed before these processes are finished, the time spent on data demodulation may be shortened, or it may be necessary to perform control for causing the time of outputting pilot subcarrier signal components and the time of outputting data signal components to differ between the symbols for computing an estimated channel-response error, and the other symbols. Further, it may be necessary to prepare a large-capacity buffer for allowing processing delay to accumulate signals, which inevitably increases the chip area or module size.

A detailed description will be given of the operation of the eighth embodiment.

In general, Fourier transformers used for OFDM transmission are FFTs. This is because DFTs have redundancy, and hence execute a large number of computations and require a large circuit scale, compared to FFTs. On the other hand, FFTs cannot start processing before a preset number of samples of one OFDM symbol are received, although this depends upon the loading scheme of FFTs. Accordingly, when FFTs are used, the number of computations can be reduced, processing delay inevitably occurs.

Since DFTs can perform processing in units of samples, they are substantially free from processing delay. In light of this, only pilot subcarrier signal components are processed by a DFT and transformed into frequency-domain signal components in units of samples. As a result, the pilot subcarrier signal components can be transformed into frequency-domain signal components a little time after the signal components of one OFDM symbol are received.

A description will now be given of a method for transforming, for example, a k^{th} subcarrier signal component into a frequency-domain signal component. Assume here that uᵢ^{(m)}(t) is the signal component as the t^{th} sample of the m^{th} OFDM symbol received by the i^{th} receiving antenna. To extract the k^{th} subcarrier signal component of the m^{th} OFDM symbol, processing as shown in the following equation (127) is performed on each sample:

$${r}_{i}^{( k )} ( m ) = \frac{1}{\sqrt{N}} {\sum }_{t = 0}^{N - 1} {u}_{i}^{( m )} ( t ) \cdot {e}^{- j 2 π \frac{kt}{N}} \qquad ( 127 )$$

This process enables the signal component of the k^{th} subcarrier of the m^{th} OFDM symbol to be extracted. In the case of the subcarrier arrangement shown in FIG. 9, the subcarriers with subcarrier numbers −21, −7, 7 and 21 are pilot subcarriers, and the pilot extraction unit 1601 extracts the signal components of the four pilot subcarriers using the equation (127). As a result, the signal components of the pilot subcarriers are transformed into frequency-domain signal components a little time after one OFDM symbol is received. In contrast, FFTs require a greater processing delay, therefore much time is required to transform data-subcarrier signal components into frequency-domain signal components. If an estimated channel-response error is computed and corrected within the processing delay of the FFTs, it is not necessary to perform processing at different times between the symbols for performing correction during data demodulation, and the other symbols. As a result, the control process is simplified.

The methods of computing and correcting the estimated channel-response error components are similar to those of the first to seventh embodiments, and therefore not described in detail.

For the estimation of phase errors in the phase correction unit 1606, either the signals extracted by the pilot extraction unit 1601 or the signals output from the Fourier transformers 1131 and 1132 may be used.

When using the signals extracted by the pilot extraction unit 1601, a certain time exists after pilot-subcarrier signal components are transformed into frequency-domain signal components, and before data-subcarrier signal components are transformed into frequency-domain signal components. This is advantageous since much time can be used for estimating phase errors. In contrast, when using the signals output from the Fourier transformers 1131 and 1132, the pilot extraction unit 1601 can be deactivated for processing the OFDM symbols other than those used for acquiring an estimated channel-response error. This reduces the consumption of power. A controller (not shown) controls the activation/deactivation of the elements including the pilot extraction unit 1601.

Further, the phase correction unit 1606 of the eighth embodiment can select signals extracted by the pilot extraction unit 1601 or the signals from the Fourier transformers 1131 and 1132, as circumstances require.

As described above, in the eighth embodiment, the estimated channel-response error due to frequency offset and phase noise can be corrected to thereby realize highly accurate MIMO demodulation. Also, since only pilot-subcarrier signal components are extracted before correction without using the Fourier transformers, the time for computing and correcting the estimated channel-response error can be set longer. This enables the time of MIMO demodulation to be equal between the symbols for computing the estimated channel-response error, and the other symbols. As a result, control for time adjustment is not necessary, and the circuit structure can be simplified.

### Ninth Embodiment

A wireless receiving apparatus according to a ninth embodiment has the same configuration as that of the first to eighth embodiments shown in FIGS. 11 to 16, and is similar to the first to eighth embodiments in that an estimated channel-response error, caused by the frequency offset between the transmission apparatus and wireless receiving apparatus and phase noise resulting therefrom, is corrected using pilot subcarriers. The ninth embodiment differs from the first to eighth embodiments in that in the former, only part of the pilot subcarriers are used to acquire an estimated channel-response error.

As described in the first embodiment, if the rank of the pilot matrix as given by the equation (37) satisfies the following conditions determined in accordance with the type of a sequence of known signal components for channel response estimation, estimation can be performed using pilot subcarriers:

1. When an orthogonal sequence is used as a known signal sequence for channel response estimation (i.e., the rows of X^{(k)} in the equation (10) are orthogonal to each other),

(Condition) the rank of the pilot matrix is equal to the number of streams.

2. When an orthogonal sequence is not used as a known signal sequence for channel response estimation,

(Condition) the rank of the pilot matrix is equal to the square of the number of streams.

Consideration will be given to an example in which the pilot subcarriers are arranged as shown in FIG. 9, and each pilot subcarrier transmits a signal component as shown in the equation (103).

When an orthogonal sequence as given by the equation (90) or (93) is transmitted as a sequence of known signal components for channel response estimation, the pilot matrix of pilot subcarriers is expressed as the equation (92) or (94), from which it is understood that even if only a single pilot subcarrier, the rank is equal to the number of streams, and estimation can be performed.

In contrast, when an orthogonal sequence is not used as a sequence of known signal components for channel response estimation as shown in the equation (15), the pilot matrix of pilot subcarriers is expressed as the equation (51) or (34), and it is necessary to use two or more subcarriers that transmit appropriate combinations of pilot signal components.

When pilot signal components as given by the equation (103) are transmitted, if one of the following four combinations of pilot subcarriers is selected, estimated channel-response error components can be acquired using only two pilot subcarriers:

(−21, −7), (−21, 21), (−7, 7), (7, 21)

Since the sequence of known signal components for channel response estimation and that of transmitted pilot signal components are preset, if a particular combination of pilot subcarriers, known to the wireless receiving apparatus, is selected, estimated channel-response error components can be acquired without using all pilot subcarriers.

Any one of the above-mentioned four combinations of pilot subcarriers may be selected. The estimated-channel-response-error correction unit can set the processing time long, if it corrects the estimated channel-response error or the values computed by the MIMO demodulation preprocessing unit, and uses pilot subcarriers early output from the Fourier transformers to set, long, the time before the start of data demodulation. Similarly, when the pilot extraction unit 1601 is used, the same advantage as the above can be acquired if it does not extract pilot subcarriers in a parallel manner, but performs sequential extraction of pilot subcarriers while selecting a combination of early output pilot subcarriers.

Under a frequency-selective-fading environment in which subcarriers have different channel characteristic values, the accuracy of computing an estimated channel-response error can be enhanced by selecting a combination of subcarriers excellent in channel response characteristic.

To this end, the estimated-channel-response-error computation unit is designed to deal with all combinations of subcarriers, and selects an appropriate combination in light of the channel response values of the subcarriers. As channel response parameters for selection, for example, received-signal power and the capacity (communication path capacity) given by the following equation (128) are used. A combination of subcarriers, which provides high power or capacity, is selected and used.

$$C = {log}_{2} det ( \frac{S}{{σ}^{2} {N}_{t}} {\hat{H}}^{( k )} {\hat{H}}^{( k ) H} + I ) \qquad ( 128 )$$

When a combination of subcarriers is selected, the combination of subcarriers that provides highest power or capacity may be selected from all combinations. Alternatively, the order of priority concerning the combinations of subcarriers may be predetermined, and a combination of a lower priority be selected only when the received-signal power and capacity of a combination of a higher priority are less than threshold values. The order of priority is, for example, the order of pilot subcarriers output from the Fourier transformers or pilot extraction unit.

No detailed description is given of the method of correcting estimated channel-response values by the estimated-channel-response-error correction unit using Φ⁻¹ estimated as the above, and the operations of the MIMO demodulation preprocessing unit, phase correction unit and MIMO demodulator, since they are identical to those of the first to eighth embodiments.

As described above, in the ninth embodiment, the estimated channel-response error due to frequency offset and phase noise can be corrected, thereby realizing highly accurate MIMO demodulation. Further, since only part of the subcarriers are used to compute the estimated channel-response error, the number of computations and hence the consumption of power can be reduced. Furthermore, the use of only part of the subcarriers can increase the time spent on the computation and correction of the estimated channel-response error.

### Tenth Embodiment

A wireless receiving apparatus according to a tenth embodiment is similar to the first to ninth embodiments in that an estimated channel-response error, caused by the frequency offset between the transmission apparatus and wireless receiving apparatus and phase noise resulting therefrom, is computed using pilot subcarriers, and the estimated channel response or the values acquired by the MIMO demodulation preprocessing unit are corrected. The tenth embodiment differs from the first to ninth embodiments in the number of the streams of received signals.

Referring to FIG. 17, the configuration of the wireless receiving apparatus of the tenth embodiment will be described. FIG. 17 shows a configuration example of the wireless receiving apparatus of the tenth embodiment, in which the number of to-be-multiplexed streams is 4, and the number of receiving antennas is 4.

The wireless receiving apparatus of the tenth embodiment comprises receiving antennas 1101, 1102, 1701 and 1702, radio units 1111, 1112, 1711 and 1712, GI removal units 1121, 1122, 1721 and 1722, Fourier transformers 1131, 1132, 1731 and 1732, channel-response estimation unit 1741, estimated-channel-response-error computation unit 1742, estimated-channel-response-error correction unit 1143, phase correction unit 1743, MIMO demodulation preprocessing unit 1144 and MIMO demodulator 1744.

The configuration of a transmission apparatus for transmitting signals received by the wireless receiving apparatus of the tenth embodiment is similar to the transmission apparatus shown in FIG. 1 for transmitting two streams, except that in the former, the number of each of radio units, GI addition units, inverse Fourier transformers and modulators is 4 so that four streams of signals can be spatially multiplexed. Since the basic function and operation are similar between both the transmission apparatuses, no detailed description is given thereof.

The channel-response estimation unit 1741 will be described. The estimation method employed in the channel-response estimation unit 1741 is similar to that employed in the case where the number of streams is 2. In general, estimation is performed using the equation (12). However, when a certain type of channel-response estimation known signals are used, even if four streams are used, an estimated channel-response error can be computed by a simple computation, such as addition or subtraction of the channel-response estimation known signals, as shown in the equations (18a), (18b), (19a) and (19c). Alternatively, time-domain signals may be used for estimation, as in the channel-response estimation unit 1301 shown in FIG. 13.

Consideration will be given to the estimated channel-response error computed as the above. The estimated channel-response error computed is given by the equations (24) and (25), as in the case where the number of streams is 2. Further, as in the first to ninth embodiments where the number of streams is 2, an estimated error can be computed, using estimated channel response values, and the pilot matrix of each subcarrier determined in accordance with the type of known symbols for channel response estimation and pilot transmission scheme employed, as shown in the equations (36), (51), (92) and (94).

Assume here that a frame format similar to that shown in FIG. 10 is employed for the case where the number of streams is 4, and known signals for channel response estimation as shown in FIG. 19 are used. In this case, the estimated channel-response error matrix Φ is given by the following equations (129), (130), (131), (132) and (133):

$$\begin{matrix}{Φ}^{- 1} = \frac{1}{4} [ \begin{matrix}α & β & γ & - δ \\ β & α & δ & - γ \\ γ & δ & α & - β \\ - δ & - γ & - β & α\end{matrix} ] \\ where , & ( 129 ) \\ α = {e}^{- j {φ}_{1}} + {e}^{- j {φ}_{2}} + {e}^{- j {φ}_{3}} + {e}^{- j {φ}_{4}} & ( 130 ) \\ β = {e}^{- j {φ}_{1}} - {e}^{- j {φ}_{2}} - {e}^{- j {φ}_{3}} + {e}^{- j {φ}_{4}} & ( 131 ) \\ γ = {e}^{- j {φ}_{1}} - {e}^{- j {φ}_{2}} + {e}^{- j {φ}_{3}} - {e}^{- j {φ}_{4}} & ( 132 ) \\ δ = {e}^{- j {φ}_{1}} + {e}^{- j {φ}_{2}} - {e}^{- j {φ}_{3}} - {e}^{- j {φ}_{4}} & ( 133 )\end{matrix}$$

As a result, the pilot matrix with subcarrier number k can be expressed as the following equation (134):

$${P}^{( k )} ( m ) = [ \begin{matrix}{p}_{1}^{( k )} ( m ) & {p}_{2}^{( k )} ( m ) & {p}_{3}^{( k )} ( m ) & - {p}_{4}^{( k )} ( m ) \\ {p}_{2}^{( k )} ( m ) & {p}_{1}^{( k )} ( m ) & - {p}_{4}^{( k )} ( m ) & {p}_{3}^{( k )} ( m ) \\ {p}_{3}^{( k )} ( m ) & - {p}_{4}^{( k )} ( m ) & {p}_{1}^{( k )} ( m ) & {p}_{2}^{( k )} ( m ) \\ {p}_{4}^{( k )} ( m ) & - {p}_{3}^{( k )} ( m ) & - {p}_{2}^{( k )} ( m ) & - {p}_{1}^{( k )} ( m )\end{matrix} ] \qquad ( 134 )$$

Using the above pilot matrix and estimated channel response, the inverse matrix of the estimated channel-response error matrix Φ can be estimated as in the first to ninth embodiments in which the number of streams is 2. Similarly, the channel response values computed by the estimated channel-response error computation unit, using the acquired Φ⁻¹, or the values output from the MIMO demodulation preprocessing unit can be corrected by the same method as employed in the first to ninth embodiments.

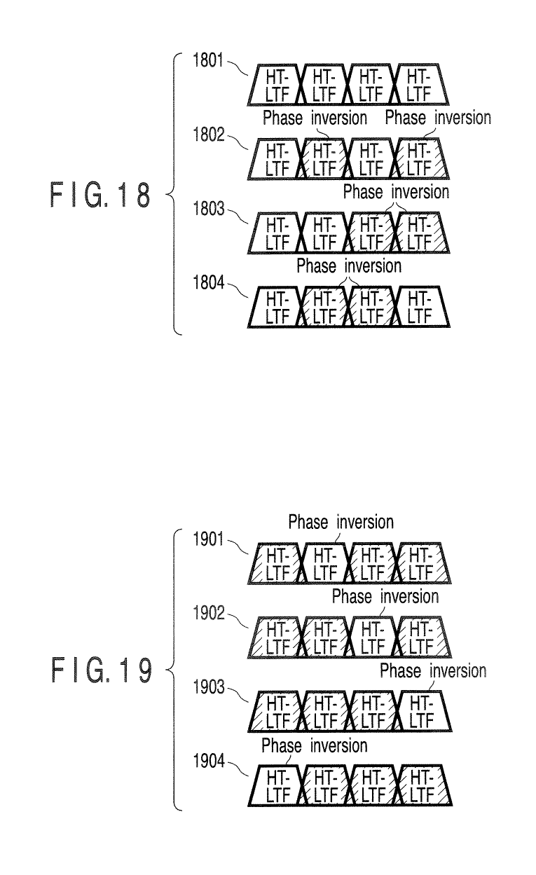

Assume also that Hadamard signals are used as known signals for channel response estimation as shown in FIG. 18. In this case, Φ⁻¹ and p^{(k)}(m) are given by the following equations (135), (136), (137), (138), (139) and (140):

$$\begin{matrix}{P}^{( k )} ( m ) = [ \begin{matrix}{p}_{1}^{( k )} ( m ) & {p}_{2}^{( k )} ( m ) & {p}_{3}^{( k )} ( m ) & {p}_{4}^{( k )} ( m ) \\ {p}_{2}^{( k )} ( m ) & {p}_{1}^{( k )} ( m ) & {p}_{4}^{( k )} ( m ) & {p}_{3}^{( k )} ( m ) \\ {p}_{3}^{( k )} ( m ) & {p}_{4}^{( k )} ( m ) & {p}_{1}^{( k )} ( m ) & {p}_{2}^{( k )} ( m ) \\ {p}_{4}^{( k )} ( m ) & {p}_{3}^{( k )} ( m ) & {p}_{2}^{( k )} ( m ) & {p}_{1}^{( k )} ( m )\end{matrix} ] & ( 135 ) \\ {Φ}^{- 1} = \frac{1}{4} [ \begin{matrix}α & β & γ & δ \\ β & α & δ & γ \\ γ & δ & α & β \\ δ & γ & β & α\end{matrix} ] \\ where , & ( 136 ) \\ α = {e}^{- j {φ}_{1}} + {e}^{- j {φ}_{2}} + {e}^{- j {φ}_{3}} + {e}^{- j {φ}_{4}} & ( 137 ) \\ β = {e}^{- j {φ}_{1}} - {e}^{- j {φ}_{2}} + {e}^{- j {φ}_{3}} - {e}^{- j {φ}_{4}} & ( 138 ) \\ γ = {e}^{- j {φ}_{1}} + {e}^{- j {φ}_{2}} - {e}^{- j {φ}_{3}} - {e}^{- j {φ}_{4}} & ( 139 ) \\ δ = {e}^{- j {φ}_{1}} - {e}^{- j {φ}_{2}} - {e}^{- j {φ}_{3}} + {e}^{- j {φ}_{4}} & ( 140 )\end{matrix}$$

Thus, as in the case where the number of streams is 2, different pilot matrices are acquired when different types of known signals are used for channel response estimation. However, since both known signals for channel response estimation and pilot signals are known to the wireless receiving apparatus, the format of Φ can be beforehand estimated from the equation (25), and the pilot matrix of the pilot signals can also be acquired from the equation (31).

Although the tenth embodiment employs the sequences shown in FIGS. 18 and 19 as known signals for channel response estimation, the known signals are not limited to them. Other types of sequences can also be used if their estimated channel-response error components and pilot matrices are computed using the equations (25) and (31).

In the tenth embodiment, although the number of streams is set to 4, it is not limited to this. If a pilot matrix acquired by expanding the pilot matrix of subcarriers given by the equations (25), (31) and (37) satisfies certain conditions.

No detailed description is given of the method of correcting estimated channel-response values by the estimated-channel-response-error correction unit using Φ⁻¹ estimated as the above, and the operations of the MIMO demodulation preprocessing unit, phase correction unit and MIMO demodulator. This is because the basic structure and method are similar between the tenth embodiment and the first to ninth embodiments, and it is sufficient if the method employed in the first to ninth embodiments is applied to four receiving antennas and four streams.

As described above in detail, in the tenth embodiment, the estimated channel-response error due to frequency offset and phase noise can be corrected, thereby realizing highly accurate MIMO demodulation. Further, even if the number of streams is more than 2, the estimated channel-response error can be corrected by the consideration of a sequence of known signals for channel response estimation.

In the wireless receiving apparatuses and methods employed in the embodiments, an estimated channel-response error is computed and corrected to enhance the accuracy of channel response estimation and hence receiving performance. Further, in the embodiments, the estimated channel-response error due to phase errors is corrected to enhance accuracy of demodulation and hence the error ratio characteristic.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless receiving apparatus comprising:
a plurality of antennas;
a receiving unit configured to receive a plurality of multiple input multiple output-orthogonal frequency division multiplexing (MIMO-OFDM) signals via the antennas;
an estimation unit configured to estimate a plurality of channel response values of subcarriers included in the MIMO-OFDM signals;
a first computation unit configured to compute an estimated channel-response error common to the subcarriers based on the estimated channel response values;
a response correction unit configured to correct the estimated channel response values using the estimated channel-response error; and
a second computation unit configured to perform preprocessing for demodulating the MIMO-OFDM signals, using the corrected channel response values.

2. The apparatus according to claim 1, wherein the second computation unit is configured to perform preprocessing, using the corrected channel response values to produce preprocessed channel response values,
the apparatus further comprising:
a phase correction unit configured to correct a plurality of phases of the MIMO-OFDM signals, using the corrected channel response values; and
a demodulation unit configured to demodulate the MIMO-OFDM signals having the corrected phases, using the preprocessed channel response values.

3. The apparatus according to claim 1, wherein the first computation unit is configured to compute an estimated channel-response error corresponding to at least one of the subcarriers, using a received-signal component of the at least one of the subcarriers, compute a weight for extracting the estimated channel-response error corresponding to the at least one of the subcarriers, and compute the estimated channel-response error common to the subcarriers, using the computed weight.

4. The apparatus according to claim 3, wherein the first computation unit is configured to generate a signal matrix from a received-signal sequence of the subcarriers, in accordance with a known signal sequence for channel response estimation, the known signal sequence being included in the MIMO-OFDM signals, compute an inverse matrix of the signal matrix, using the estimated channel response values of the subcarriers, the inverse matrix being common to the subcarriers, and compute the weight using the inverse matrix.

5. The apparatus according to claim 3, wherein the first computation unit is configured to generate a signal matrix from a received-signal sequence of the subcarriers, in accordance with a known signal sequence for channel response estimation, the known signal sequence being included in the MIMO-OFDM signals, detect a noise power from the received signal sequence, compute an inverse matrix of the signal matrix, using the estimated channel response values of the subcarriers and the detected noise power, the inverse matrix being common to the subcarriers, and compute the weight using the inverse matrix.

6. The apparatus according to claim 1, wherein the first computation unit is configured to compute a weight for extracting a signal component transmitted for each of the subcarriers, using a received-signal component of at least one of the subcarriers, multiply the received-signal component by the weight for each of the subcarriers to obtain a plurality of multiplied received-signal components, and combine the multiplied received-signal components, in accordance with a type of transmission signal sequence to obtain the estimated channel-response error.

7. The apparatus according to claim 6, wherein when the subcarriers include combinations of subcarriers which transmit transmission signal vectors linearly dependent on each other, each vector including, as an element, at least one signal component to be subjected to spatial multiplexing, the first computation unit is configured to multiply received-signal components of the combinations by weights obtained from the computed weight to extract signals transmitted in the subcarriers, subject the extracted signals to weighted summation, and combine a signal acquired by the weighted summation with a signal in accordance with a transmitted signal sequence to obtain the estimated channel-response error.

8. The apparatus according to claim 1, wherein the first computation unit is configured to compute the estimated channel-response error based on a Total Least Square method, using a signal matrix generated from a signal sequence transmitted in at least one of the subcarriers based on a known signal sequence for channel response estimation, the known signal sequence being included in the MIMO-OFDM signals, and also using the estimated channel response values and a received-signal component of the at least one of the subcarriers.

9. The apparatus according to claim 1, wherein the response correction unit is configured to correct an estimated channel response values of a known pilot subcarrier included in the subcarriers, using the estimated channel-response error.

10. The apparatus according to claim 1, wherein the first computation unit is configured to compute an estimated channel-response error corresponding to at least one known pilot subcarrier included in the subcarriers, using the at least one known pilot subcarrier, compute a weight for extracting the estimated channel-response error corresponding to the at least one known pilot subcarrier, and compute the estimated channel-response error common to the subcarriers, using at least one computed weight.

11. The apparatus according to claim 10, wherein the at least one known pilot subcarrier includes combinations of pilot subcarriers, each of which satisfies a condition that a rank of a signal matrix is equal to a square of number of streams used for spatial multiplexing, the signal matrix being acquired from known signal sequences of the subcarriers and used for estimation, and also from signal sequences transmitted in pilot subcarriers.

12. The apparatus according to claim 11, wherein the first computation unit is configured to use combinations of pilot subcarriers which are included in the combinations satisfying the condition and provide a high receiving power.

13. The apparatus according to claim 11, wherein the first computation unit is configured to use combinations of pilot subcarriers which are included in the combinations satisfying the condition and provide a high communication capacity.

14. The apparatus according to claim 10, wherein when an orthogonal signal sequence is transmitted as a known signal sequence for channel response estimation, the known signal sequence being included in the MIMO-OFDM signals, the at least one known pilot subcarrier includes combinations of pilot subcarriers, each of which satisfies a condition that a rank of a signal matrix is equal to number of streams used for spatial multiplexing, the signal matrix being acquired from known signal sequences of the subcarriers and used for estimation, and also from signal sequences transmitted in pilot subcarriers.

15. The apparatus according to claim 14, wherein the first computation unit is configured to use combinations of subcarriers which are included in the combinations satisfying the condition and provide a high receiving power.

16. The apparatus according to claim 14, wherein the first computation unit is configured to use combinations of pilot subcarriers which are included in the combinations satisfying the condition and provide a high communication capacity.

17. The apparatus according to claim 10, further comprising an extraction unit configured to extract a signal component of the at least one known pilot subcarrier from a time-domain signal component of each of the received MIMO-OFDM signals, and wherein the first computation unit is configured to compute the estimated channel-response error using the extracted signal component.

18. The apparatus according to claim 10, wherein the first computation unit is configured to compute the estimated channel-response error, using a signal component of an OFDM symbol subsequent to an OFDM symbol which contains a signal having a channel response value estimated by the estimation unit using a signal component of the at least one known pilot subcarrier.

19. A wireless receiving apparatus comprising:
a plurality of antennas;
a receiving unit configured to receive a plurality of multiple input multiple output-orthogonal frequency division multiplexing (MIMO-OFDM) signals via the antennas;
an estimation unit configured to estimate a plurality of channel response values of subcarriers included in the MIMO-OFDM signals;
a first computation unit configured to perform preprocessing for demodulating the MIMO-OFDM signals, using the channel response values;
a second computation unit configured to compute an estimated channel-response error common to the subcarriers based on the estimated channel response values; and
a correction unit configured to correct the estimated channel response values using the estimated channel-response error.

20. The apparatus according to claim 19, wherein the correction unit is configured to compute an inverse matrix of a matrix of the estimated channel-response error, and correct the channel response values on which the preprocessing is performed using the inverse matrix.

21. The apparatus according to claim 19, wherein the first computation unit is configured to compute a cross-correlation matrix from the MIMO-OFDM signals and complex conjugates of the MIMO-OFDM signals, and performs the preprocessing using the cross-correlation matrix.

22. The apparatus according to claim 19, wherein the second computation unit is configured to compute an estimated channel-response error corresponding to at least one known pilot subcarrier included in the subcarriers, using the at least one known pilot subcarrier, compute a weight for extracting the estimated channel-response error corresponding to the at least one known pilot subcarrier, and compute the estimated channel-response error common to the subcarriers, using at least one computed weight.

23. The apparatus according to claim 22, wherein the at least one known pilot subcarrier includes combinations of pilot subcarriers, each of which satisfies a condition that a rank of a signal matrix is equal to a square of number of streams used for spatial multiplexing, the signal matrix being acquired from known signal sequences of subcarriers and used for estimation, and also from signal sequences transmitted in pilot subcarriers.

24. The apparatus according to claim 23, wherein the second computation unit is configured to use combinations of pilot subcarriers which are included in the combinations satisfying the condition and provide a high receiving power.

25. The apparatus according to claim 23, wherein the second computation unit is configured to use combinations of pilot subcarriers which are included in the combinations satisfying the condition and provide a high communication capacity.

26. The apparatus according to claim 22, wherein when an orthogonal signal sequence is transmitted as a known signal sequence for channel response estimation, the known signal sequence being included in the MIMO-OFDM signals, the at least one known pilot subcarrier includes combinations of pilot subcarriers, each of which satisfies a condition that a rank of a signal matrix is equal to number of streams used for spatial multiplexing, the signal matrix being acquired from known signal sequences of the subcarriers and used for estimation, and also from signal sequences transmitted in pilot subcarriers.

27. The apparatus according to claim 26, wherein the second computation unit is configured to use combinations of subcarriers which are included in the combinations satisfying the condition and provide a high receiving power.

28. The apparatus according to claim 26, wherein the first computation unit is configured to use combinations of pilot subcarriers which are included in the combinations satisfying the condition and provide a high communication capacity.

29. The apparatus according to claim 22, further comprising an extraction unit configured to extract a signal component of the at least one known pilot subcarrier from a time-domain signal component of each of the received MIMO-OFDM signals, and wherein the first computation unit is configured to compute the estimated channel-response error using the extracted signal component.

30. The apparatus according to claim 22, wherein the second computation unit is configured to compute the estimated channel-response error, using a signal component of an OFDM symbol subsequent to an OFDM symbol which contains a signal having a channel response value estimated by the estimation unit using a signal component of the at least one known pilot subcarrier.

31. A wireless signal receiving method comprising:
receiving a plurality of multiple input multiple output-orthogonal frequency division multiplexing (MIMO-OFDM) signals;
estimating a plurality of channel response values of subcarriers contained in the MIMO-OFDM signals;
computing an estimated channel-response error common to the subcarriers based on the estimated channel response values;
correcting the estimated channel response values using the estimated channel-response error; and
performing preprocessing for demodulating the MIMO-OFDM signals, using the corrected channel response values.

32. A wireless signal receiving method comprising:
receiving a plurality of multiple input multiple output-orthogonal frequency division multiplexing (MIMO-OFDM) signals;
estimating a plurality of channel response values of subcarriers included in the MIMO-OFDM signals;
performing preprocessing for demodulating the MIMO-OFDM signals, using the channel response values;
computing an estimated channel-response error common to the subcarriers based on the estimated channel response values; and
correcting the estimated channel response values using the estimated channel-response error.
